(19) United States
(12) Patent Application Publication
(10) Pub. No.: US 2012/0304134 A1
(43) Pub. Date: Nov. 29, 2012

(54) EXPOSURE DATA GENERATION METHOD

(75) Inventors: Shinji SUGATANI, Hachiohji (JP); Takashi MARUYAMA, Koto (JP)

(73) Assignee: FUJITSU SEMICONDUCTOR LIMITED, Yokohama-shi (JP)

(21) Appl. No.: 13/427,179

(22) Filed: Mar. 22, 2012

(30) Foreign Application Priority Data
May 24, 2011 (JP) 2011-115419

(51) Int. Cl. G06F 17/50

(52) U.S. Cl. 716/55

(57) ABSTRACT

An exposure data generation method includes generating a first multi-layer wiring pattern including a plurality of wiring layers according to a netlist and a wiring rule; dividing a layer pattern of each layer included in the generated first multi-layer wiring pattern by a subfield; by referring to a pattern database in which a subfield pattern of a wiring layer, included in a second multi-layer wiring pattern generated in the subfield according to the wiring rule, and a pattern identifier corresponding to the subfield pattern are registered, extracting the pattern identifier of the subfield pattern corresponding to the divided layer pattern of the first multi-layer wiring pattern; and generating exposure data including the extracted pattern identifier and an exposure position of the subfield pattern corresponding to the extracted pattern identifier.

### CROSS-REFERENCE TO RELATED APPLICATION

This application is based upon and claims the benefit of priority of the prior Japanese Patent Application No. 2011-115419, filed on May 24, 2011, the entire contents of which are incorporated herein by reference.

### FIELD OF THE INVENTION

The embodiments discussed herein are related to a method for generating exposure data.

### BACKGROUND

In the manufacturing process of a semiconductor integrated circuit (IC hereafter), a desired pattern is formed on a resist film by the exposure of the resist film on a semiconductor substrate.

One method of such an exposure process is an electron beam exposure method, in which desired patterns are rendered (i.e. drawn) on the resist film by means of electron beams. As the electron beam exposure method, a Variable Shaped Beam (VSB) method is well-known, in which patterns are filled in one by one by means of the electron beams. However, in the VSB method, there is a problem of a low throughput due to a large number of exposure times.

To solve such a problem, a Character Projection (CP) method has been developed. In the CP method, a block mask having apertures corresponding to a rendering pattern is used. When the block mask is irradiated with an electron beam, a resist film is exposed by the electron beam that transmits through the aperture, and the rendering pattern is transferred accordingly. The CP method has improved the throughput of the electron beam exposure method. (For example, refer to Japanese Laid-Open Publication No. 2007-129265, Japanese Patent No. 38866995, Japanese Laid-Open Publication No. 2003-17388)

As the shape of the apertures provided on the block mask (hereafter referred to as a “block pattern”), a pattern that frequently appears in an IC layout pattern is selected.

The IC layout pattern includes patterns of a gate circuit (hereafter simply referred to as gate) and a memory cell, and a wiring pattern to connect such patterns.

The gate and the memory cell patterns include a multiplicity of patterns having an identical shape. Therefore, the CP method is suitable to expose the gate pattern and the memory cell pattern.

However, since the wiring patterns have a variety of shapes, it is not easy to extract appropriate block patterns from an IC wiring pattern. Therefore, the VSB method is used to expose the wiring pattern.

### SUMMARY

According to an aspect of the invention, an exposure data generation method includes generating a first multi-layer wiring pattern including a plurality of wiring layers according to a netlist and a wiring rule; dividing a layer pattern of each layer included in the generated first multi-layer wiring pattern by a subfield; by referring to a pattern database in which a subfield pattern of a wiring layer, included in a second multi-layer wiring pattern generated in the subfield according to the wiring rule, and a pattern identifier corresponding to the subfield pattern are registered, extracting the pattern identifier of the subfield pattern corresponding to the divided layer pattern of the first multi-layer wiring pattern; and generating exposure data including the extracted pattern identifier and an exposure position of the subfield pattern corresponding to the extracted pattern identifier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration diagram of an electron beam exposure apparatus to render a multi-layer wiring pattern on a resist film, by use of exposure data generated according to the embodiment 1;

FIG. 2 is a plan view of the block mask;

FIG. 3 is a plan view of each block area;

FIG. 4 is a configuration diagram of a computer to execute the exposure data generation method according to the embodiment 1;

FIG. 5 is a flowchart of the exposure pattern generation method according to the embodiment 1;

FIG. 6 illustrates an example of a first multi-layer wiring pattern generated in the placement and routing step:

FIG. 7 is a plan view illustrating an example of a first wiring layer;

FIG. 8 is a plan view illustrating an example of a second wiring layer;

FIG. 9 is a plan view illustrating an example of a via layer;

FIG. 10 illustrates an example of a first wiring layer generated according to the standard wiring rule;

FIG. 11 illustrates an example of a second wiring layer generated according to the standard wiring rule;

FIG. 12 illustrates an example of a via layer generated according to the standard wiring rule;

FIG. 13 is a flowchart of the exposure data generation step;

FIG. 14 illustrates an example of the pattern database according to the embodiment 1;

FIG. 15 illustrates an example of the pattern database according to the embodiment 1;

FIG. 16 illustrates an example of the pattern database according to the embodiment 1;

FIG. 17 is an example of exposure data generated according to the embodiment 1.

FIG. 18 is a partial enlarged view of the block area corresponding to the first wiring layer.

FIG. 19 is a plan view of a resist film having the layer pattern of the first wiring layer transferred thereon.

FIG. 20 is a plan view of a resist film having the layer pattern of the via layer transferred thereon.

FIG. 21 illustrates an example of a pattern database according to the embodiment 2.

FIG. 22 is a diagram illustrating a rule to form the subfield pattern corresponding to the first wiring layer, from the first base pattern and the plurality of first wiring formation patterns;

FIG. 23 is a partial enlarged view of the block area having blocks corresponding to the partial patterns depicted in FIG. 21;

FIG. 24 is a diagram illustrating a process to transfer the subfield pattern to the resist film;

FIG. 25 is a diagram illustrating the partial patterns of the second wiring layer;

FIG. 26A illustrates an example of a first wiring layer in a state that each first stripe pattern and each second stripe pattern are connected by one via pattern;

FIG. 26B illustrates an example of a second wiring layer in a state that each first stripe pattern and each second stripe pattern are connected by one via pattern;

FIG. 26C illustrates an example of a via layer in a state that each first stripe pattern and each second stripe pattern are connected by one via pattern;

FIGS. 27 are explanation diagrams of the wiring rule according to the embodiment 3;

FIGS. 28 are explanation diagrams of the wiring rule according to the embodiment 3;

FIGS. 29A is an explanation diagram of the partial patterns forming the subfield pattern of the first wiring layer in the embodiment 3;

FIGS. 29B is an explanation diagram of the partial patterns forming the subfield pattern of the first wiring layer in the embodiment 3;

FIGS. 29C is an explanation diagram of the partial patterns forming the subfield pattern of the first wiring layer in the embodiment 3;

FIGS. 29D is an explanation diagram of the partial patterns forming the subfield pattern of the first wiring layer in the embodiment 3;

FIG. 30 is an explanation diagram of the partial patterns forming the subfield pattern of the second wiring layer 40b;

FIG. 31 is an example of partial pattern forming the subfield pattern of the via layer;

FIG. 32 is a diagram illustrating an exemplary deformation of the base pattern;

FIG. 33 is a diagram illustrating third wiring formation patterns corresponding to a second base pattern;

FIG. 34 is an example of the L&S pattern; and

FIG. 35 is an exemplary deformation of the L&S pattern.

### DESCRIPTION OF EMBODIMENTS

As described previously, the VSB method having a problem of low throughput has been used to expose the wiring pattern. As a result, there is a problem in the electron beam exposure method that throughput for rendering an overall IC layout pattern is not sufficiently high.

According to following embodiments, throughput of the electron beam exposure for wiring patterns is improved.

Preferred embodiments will be explained with reference to accompanying drawings.

### Embodiment 1

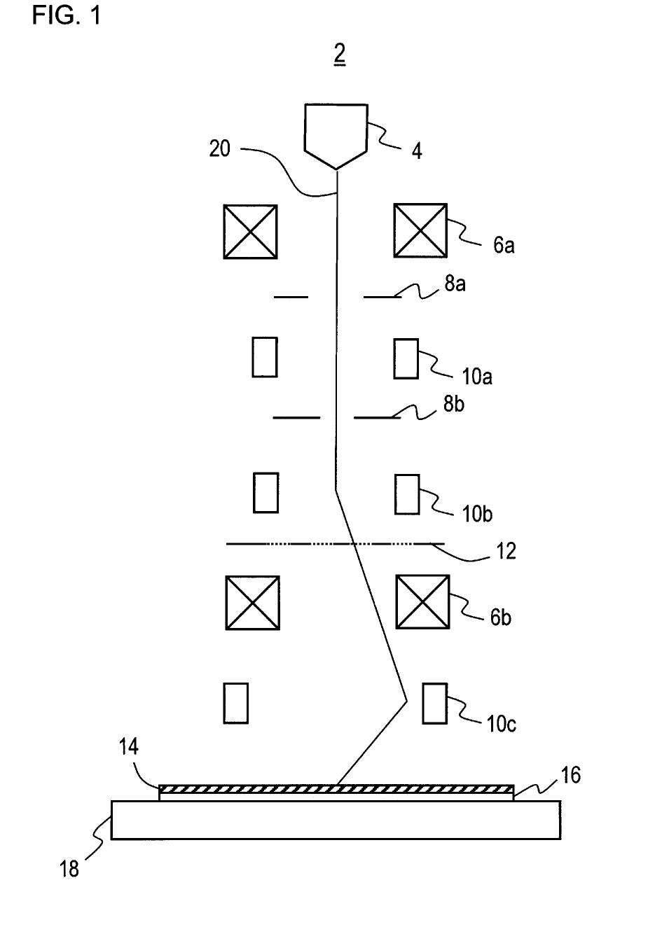

FIG. 1 is a configuration diagram of an electron beam exposure apparatus 2 to render (i.e. to draw) a multi-layer wiring pattern on a resist film, by use of exposure data generated according to the present embodiment. Additionally, an exposure pattern signifies a pattern to be rendered on a resist film 14 by the electron beam.

As illustrated in FIG. 1, the electron beam exposure apparatus (i.e. electron beam lithography apparatus) 2 includes electron gun 4, a magnetic collimator lens 6a, a first aperture 8a, a first deflector 10a, a second aperture 8b and a second deflector 10b. The first aperture 8a and the second aperture 8b have rectangular shapes.

Further, the electron beam exposure apparatus 2 includes a block mask 12, a magnetic focusing lens 6b, a third deflector 10c and a movable stage 18. On the movable stage 18, a semiconductor substrate 16 having the formed resist film 14 is mounted.

An electron beam 20 emitted from the electron gun 4 is converted into a parallel beam by the magnetic collimator lens 6a. By the first aperture 8a, the first deflector 10a and the second aperture 8b, the electron beam 20 is shaped into a rectangular beam having a substantially identical size to the block pattern.

Thereafter, by the second deflector 10b, the electron beam 20 is irradiated on a predetermined block (an area having an aperture corresponding to the block pattern) provided on the block mask 12. The electron beam 20 passing through the block mask 12 is imaged on a predetermined area of the resist film 14, by the magnetic focusing lens 6b and the third deflector 10c. As a result, the block pattern is imaged on the resist film 14. Such an exposure process is repeated until the entire patterns included in an IC layout pattern are transferred to the resist film 14.

The electron beam exposure apparatus 2 is controlled by an exposure control apparatus (not illustrated), based on exposure data described later. Here, the exposure data is recorded on a recording medium included in the exposure control apparatus.

The resist film 14 is formed of, for example, a positive type resist. Thus, the resist film having an aperture corresponding to the block pattern is formed. Such a formation is also made in the embodiments 2 and 3.

The above resist film is suitable for the formation of a multi-layer wiring pattern by means of a damascene method. Here, the resist film 14 may be formed of a negative type resist. The negative type resist is suitable for the formation of the multi-layer wiring pattern by means of a non-damascene method.

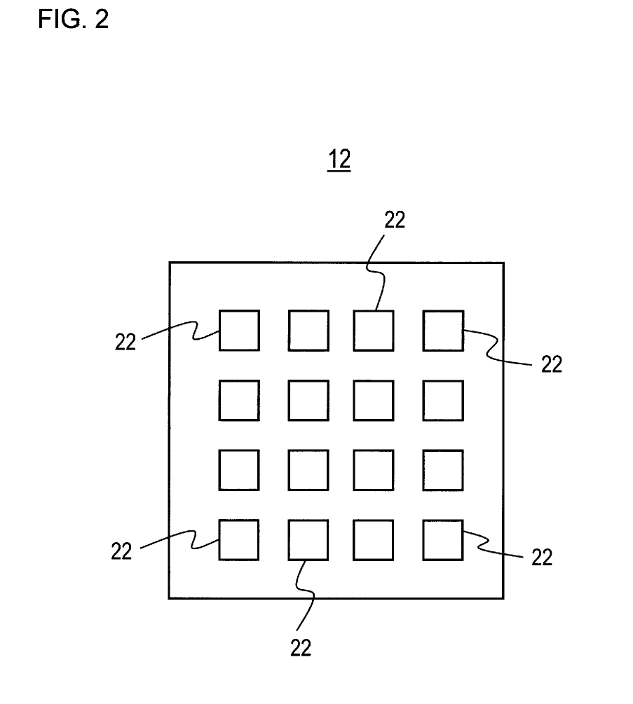

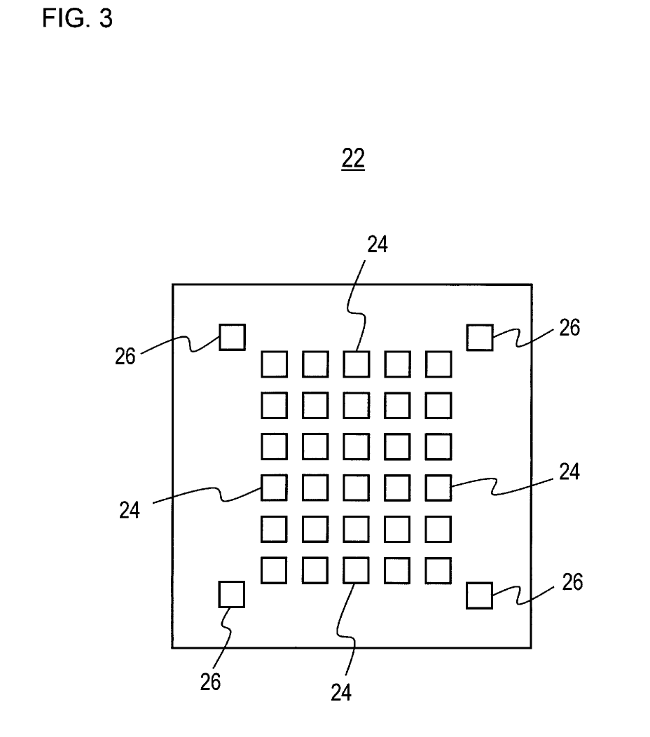

FIG. 2 is a plan view of the block mask 12. The plane shape of the block mask 12 is, for example, a square having one side length of 5 cm, or of that order. As illustrated in FIG. 2, in the block mask 12, a plurality of block areas 22 are provided. FIG. 3 is a plan view of each block area 22.

The block area 22 is a rectangular area having a diagonal of 4.4 mm, or of that order. As depicted in FIG. 3, in the central portion of the block area 22, a plurality of blocks 24 are provided. Each block 24 is, for example, a rectangular area having each side length of 1.5 μm×1.5 μm, or of that order (alternatively, 1.28 μm×40 nm or of that order). In the block 24, the aperture corresponding to the exposure pattern is disposed.

For each layer (for example, gate layer, wiring layer and via layer) included in the IC layout pattern, each block area 22 includes blocks for use to render each layer. For example, the block area 22 includes on the order of 4,000 blocks 24. At the four corners of the block area 22, rectangular slips 26 for use in the VSB method are provided.

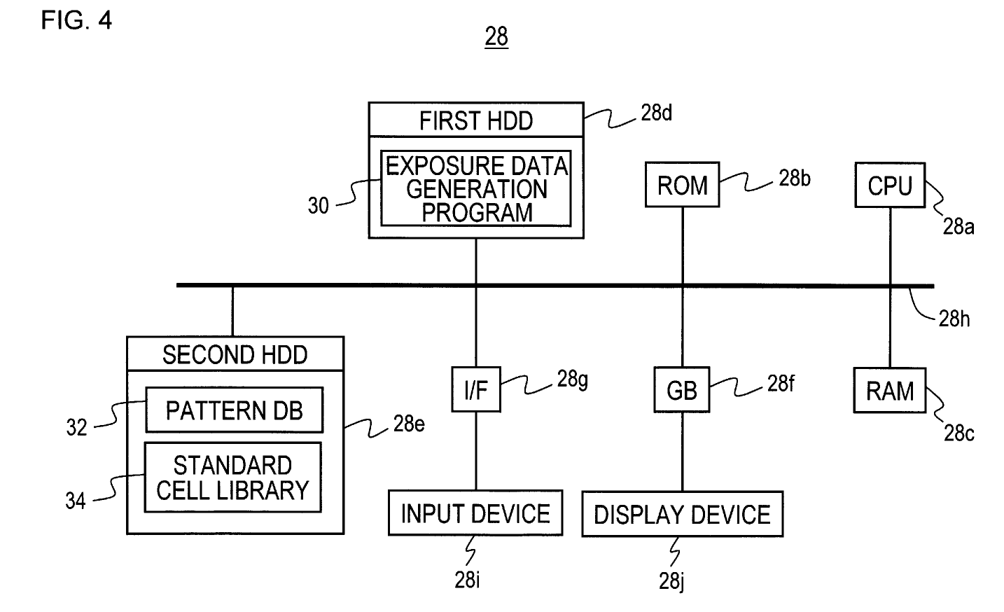

FIG. 4 is a configuration diagram of a computer 28 to execute the exposure data generation method according to the present embodiment. As illustrated in FIG. 4, the computer 28 includes CPU (Central Processing Unit) 28a, ROM (Read Only Memory) 28b and RAM (Random Access Memory) 28c. The computer 28 also includes a first HDD (Hard Disk Drive) 28d, a second HDD 28e, a GB (Graphic Board) 28f, an I/F (Interface) 28g, bus a 28h, display device 28j and an input device 28i.

CPU 28a controls the hardware devices provided in the computer 28. CPU 28a loads programs recorded in the first hard disk 28d to RAM 28c, and executes the loaded programs. In the first hard disk 28d, an exposure data generation program 30 etc. to be executed by the computer 28 are recorded. By that CPU 28a executes the exposure data generation program, the computer 28 becomes an exposure data generation device, which conducts an exposure data generation method.

In ROM 28b, a basic program etc. to be executed by CPU 28a are recorded. In RAM 28c, not only programs but data generated halfway through calculation are tentatively recorded, when CPU 28a executes a variety of types of calculation processing.

In the second hard disk 28e, a pattern database 32 and a standard cell library 34 are recorded, which will be described later. In the standard cell library 34, the function of standard cells (standard functional blocks, which are hereafter referred to as “cells”) and the cell patterns of the standard cells are recorded.

The GB 28f executes image-generating process according to image-generating instructions received from CPU 28a, converts the generated image data into picture signals. And then, the picture signals are supplied to the display device 28j. The I/F 28g changes the format of data input into the input device 28i and then forwards the date to CPU 28a etc.

CPU 28a, ROM 28b, RAM 28c, first HDD 28d, second HDD 28e, GB 28f and I/F 28g are connected to the bus 28h. Exchange of data among the above hardware is carried out through the bus 28h.

The display device 28j is, for example, an LCD (Liquid Crystal Display) monitor, which displays picture signals supplied from GB 28f. The input device 28i includes, for example, a keyboard and a mouse, and generates data according to user operations and then supplies the generated date to I/F (Interface) 28g.

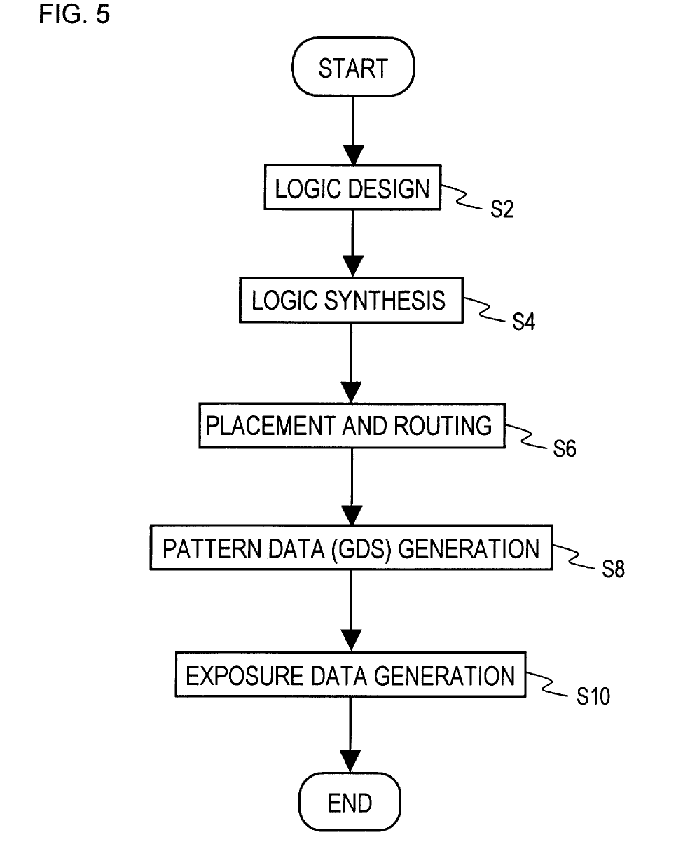

FIG. 5 is a flowchart of the exposure pattern generation method according to the present embodiment. As illustrated in FIG. 5, the exposure pattern generation method according to the present embodiment includes logic design step (S2), logic synthesis step (S4), placement and routing step (S6), pattern data generation step (S8) and exposure data generation step (S10).

Logic Design (S2) and Logic Synthesis (S4)

First, the computer 28 describes IC specifications with logic formulae (S2).

Next, the computer 28 converts the generated logic formulae into a net list (S4). The netlist includes data describing the connectivity between the cells. In the present step, the netlist is generated using the cells registered in the standard cell library 34.

The standard cell library 34 includes information for logic synthesis (S4), information for placement and routing (S6) described later, that is, information for circuit wiring, and block information. The information for logic synthesis includes size, function and performance of the standard cell, for example. The information for placement and routing includes, for example, a concrete cell shape (cell pattern), positions of an input terminal and an output terminal on which wiring is connected, and a pattern identifier of the cell pattern. The block information is information indicating a block position (position on a block mask) corresponding to each cell pattern.

Placement and Routing (S6)

According to the netlist generated by the logic synthesis step (S4), the computer 28 generates an IC layout pattern (S6). The layout pattern includes a first multi-layer wiring pattern generated according to a predetermined wiring rule. The multi-layer wiring pattern is a pattern having a plurality of layers.

Also, the layout pattern includes a gate layer pattern. In the gate layer pattern, cell patterns included in the netlist are disposed. The cell patterns are extracted from the standard cell library 34.

(i) Multi-Layer Wiring Pattern

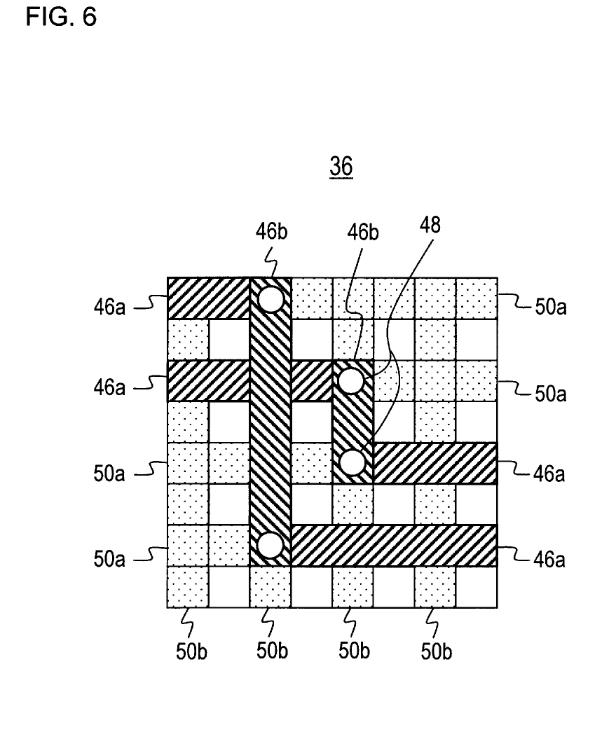

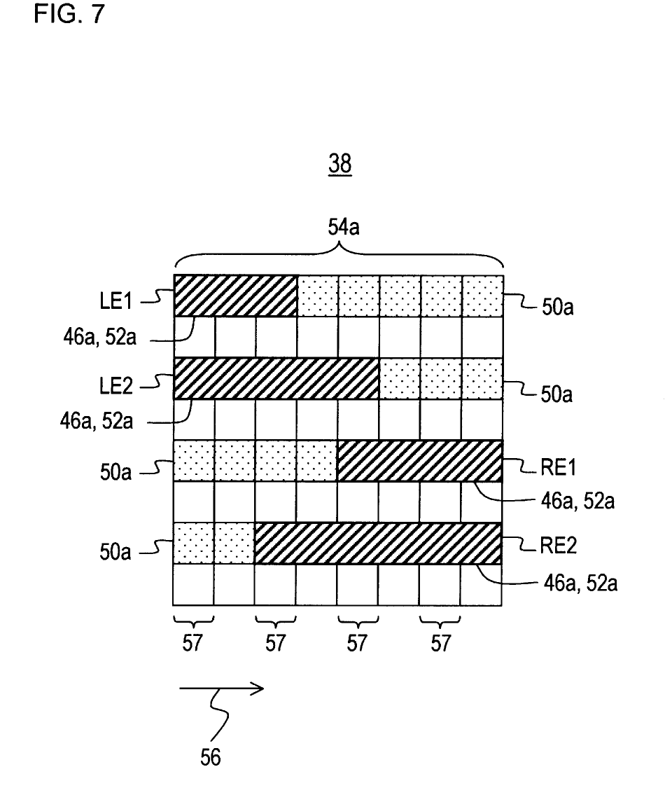

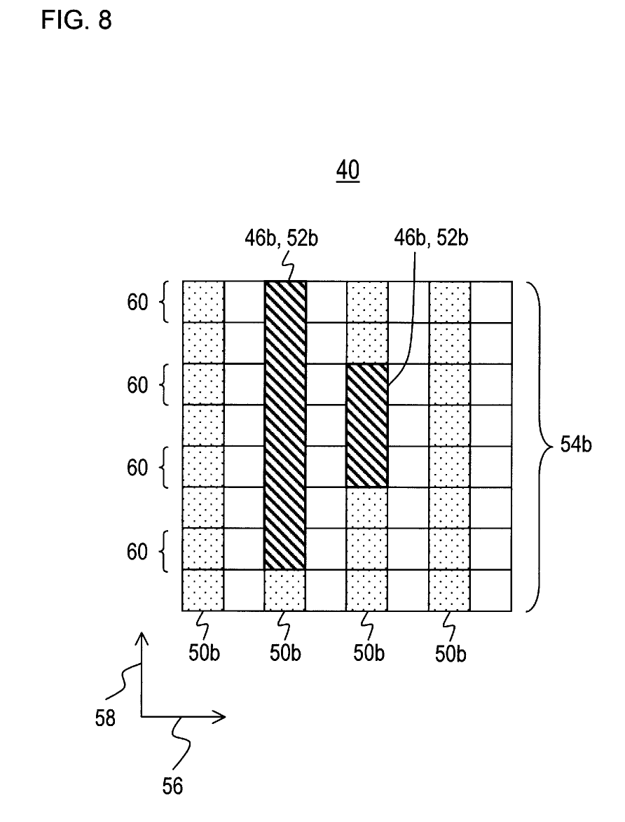

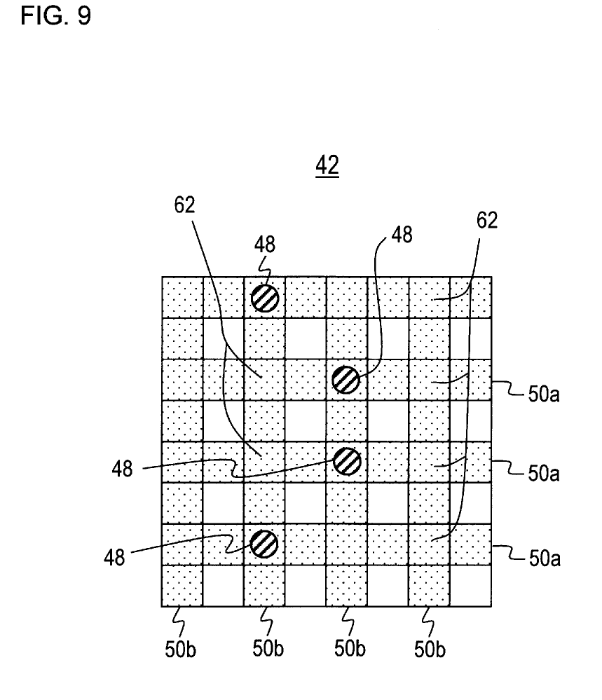

FIG. 6 illustrates an example of a first multi-layer wiring pattern 36 generated in the present step. The first multi-layer wiring pattern 36 includes a first wiring layer, a second wiring layer and a via layer disposed between the first wiring layer and the second wiring layer. FIG. 6 illustrates the laminated state of the above layers. FIG. 7 is a plan view illustrating an example of a first wiring layer 38. FIG. 8 is a plan view illustrating an example of a second wiring layer 40. Further, FIG. 9 is a plan view illustrating an example of a via layer 42.

The first wiring layer 38 includes a wiring pattern 46a to contact to one plane of an interlayer insulating film. The second wiring layer 40 includes a wiring pattern 46b to contact to the other plane of the interlayer insulating film. The via layer 42 includes hole patterns (via patterns 48 hereafter) to be formed on the interlayer insulating film. The via has a conductive material filled therein for connecting a wiring disposed on one plane of the interlayer insulating film to a wiring disposed on the other plane.

The first wiring layer 38 may have an area including a portion of the cell pattern (for example, the input terminal and the output terminal of the cell) outside the area depicted in FIG. 7. The same is also applicable to the second wiring layer 40 and the via layer 42.

Additionally, FIGS. 6 through 9 illustrate one or both of first tracks 50a and second tracks 50b, as well as each layer pattern. The tracks are band-shaped areas in which the wiring patterns 46a, 46b are disposed.

(ii) Wiring Rule

A wiring rule according to the present embodiment is a rule to generate the pattern of each layer (hereafter referred to as a layer pattern) included in the first multi-layer wiring pattern 36 having the first wiring layer 38, the second wiring layer 40 and the via layer 42 disposed between the first wiring layer and the second wiring layer. The layer pattern is a pattern for one layer of the multi-layer wiring pattern.

As illustrated in FIG. 7, in the first wiring layer 38, the computer 28 generates a layer pattern 54a of the first wiring layer 38, by disposing first stripe patterns 52a on the first tracks 50a that extend to a first direction 56 according to the above predetermined wiring rule. The first stripe patterns 52a become the first wiring patterns 46a by being disposed on the first tracks 50a.

When a portion of the cell pattern and so on are included in the first wiring layer 38, the computer 28 further includes these patterns in the layer pattern 54a of the first wiring layer 38. The same is applicable to the second wiring layer 40 and the via layer 42.

FIG. 7 also illustrates outlines 57 of the second tracks 50b which will be described later. In the layer pattern 54a of the first wiring layer 38, the first tracks 50a and the outlines 57 of the second tracks 50b are not included. Similarly, the tracks and the track outlines illustrated in other drawings are not included in the layer patterns illustrated in the respective drawings.

As illustrated in FIG. 8, in the second wiring layer 40, the computer 28 generates a layer pattern 54b of the second wiring layer 40, by disposing second stripe patterns 52b on the second tracks 50b that extend to a second direction 58 according to the above-mentioned wiring rule. The second stripe patterns 52b configure the second wiring patterns 46b by being disposed on the second tracks 50b. Here, the second direction 58 is a direction intersecting with (preferably perpendicular to) the first direction 56.

Further, as illustrated in FIG. 9, the computer 28 connects the first stripe patterns 52a to the second stripe patterns 52b, by disposing the via patterns 48 at grid points 62 according to the above-mentioned wiring rule.

Here, the grid points 62 are areas in which the first tracks 50a intersect with the second tracks 50b in a three-dimensional manner.

Now, it is assumed that, in FIG. 7, an output terminal (not illustrated) of a first cell is connected to the left end LE1 of a stripe pattern 52a located first from the top of the first wiring layer 38. Also, it is assumed an output terminal (not illustrated) of a second cell is connected to the left end LE2 of a stripe pattern 52a located second from the top.

Further, it is assumed that an input terminal (not illustrated) of a third cell is connected to the right end RE1 of a stripe pattern 52a located third from the top of the first wiring layer 38. Also, it is assumed that an input terminal (not illustrated) of a fourth cell is connected to the right end RE2 of a stripe pattern 52a located fourth from the top.

As illustrated in FIGS. 6 through 8, the stripe patterns 52a of the first wiring layer 38 are connected in a three-dimensional manner to other stripe patterns 52a of the first wiring layer 38, through the stripe patterns 52b of the second wiring layer 40 and the via patterns 48. Therefore, according to the above-mentioned predetermined wiring rule, the output terminal of the first cell (the left end LE1) is connectable to any of the input terminal of the third cell (the right end RE1) and the input terminal of the fourth cell (the right end RE2). Similarly, according to the predetermined wiring rule, the output terminal of the second cell (the left end LE2) is connectable to any of the input terminal of the third cell (the right end RE1) and the input terminal of the fourth cell (the right end RE2). In short, desired connection relationship is achievable according to the wiring rule.

The wiring rule according to the present embodiment may have a step to dispose a dummy pattern at a grid point 62. Here, the dummy pattern signifies an isolated pad pattern to be disposed on the interlayer insulating film so that CMP (Chemical Mechanical Polishing) is uniformly performed in the damascene method. The isolated pad is formed together with the wiring disposed on the interlayer insulating film.

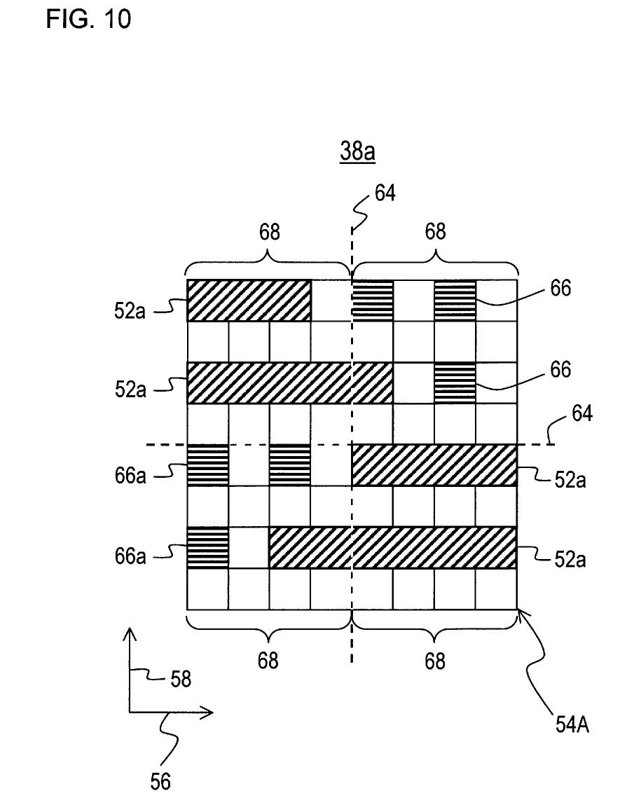

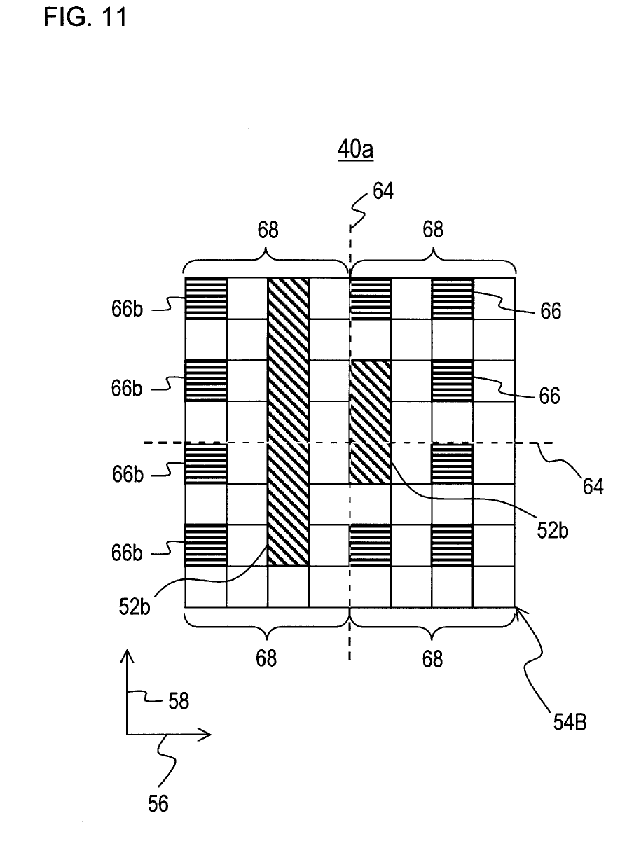

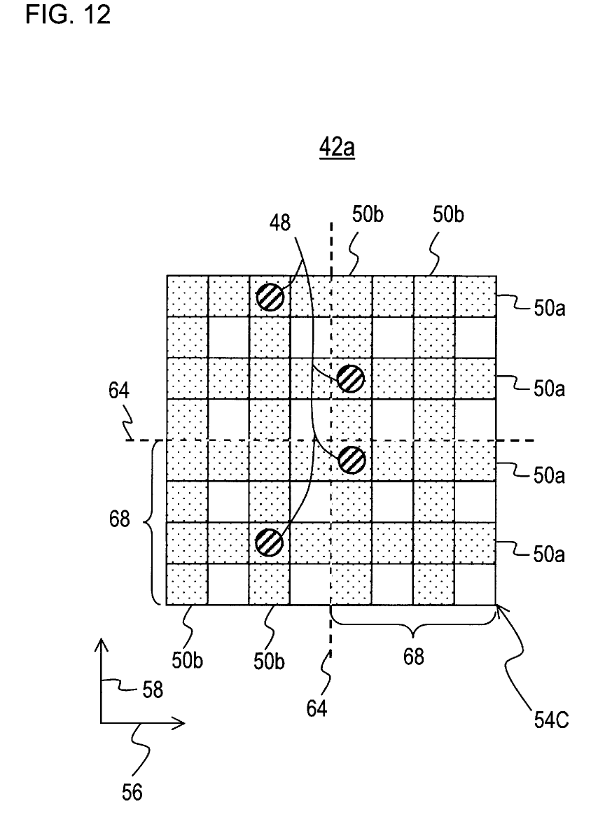

FIG. 10 illustrates an example of a first wiring layer 38a generated according to a wiring rule defined to dispose the dummy pattern (hereafter referred to as “standard wiring rule”). FIG. 11 illustrates an example of a second wiring layer 40a generated according to the standard wiring rule. FIG. 12 illustrates an example of a via layer 42a generated according to the standard wiring rule. FIGS. 10 through 12 also illustrate division lines 64 for use in the explanation of a division step that will be described later.

When generating the multi-layer wiring pattern according to the standard wiring rule, as illustrated in FIG. 10, the computer 28 disposes dummy patterns 66 at the grid points that are not included in the first stripe patterns 52a (i.e. the grid points on which the first stripe patterns 52a are not disposed), among the grid points 62 included in the first wiring layer 38a.

Also, as illustrated in FIG. 11, the computer 28 disposes dummy patterns 66 at the grid points that are not included in the second stripe patterns 52b (i.e. the grid points on which the second stripe patterns 52b are not disposed), among the grid points 62 included in the second wiring layer 40a. The following description will be given on a layer pattern illustrated in FIGS. 10 through 12 having the dummy pattern.

Pattern Data Generation Step (S8)

Next, the computer 28 converts the layout pattern generated in the placement and routing step into pattern data of a GDS (Graphic Data System) format.

Exposure Data Generation Step (S10)

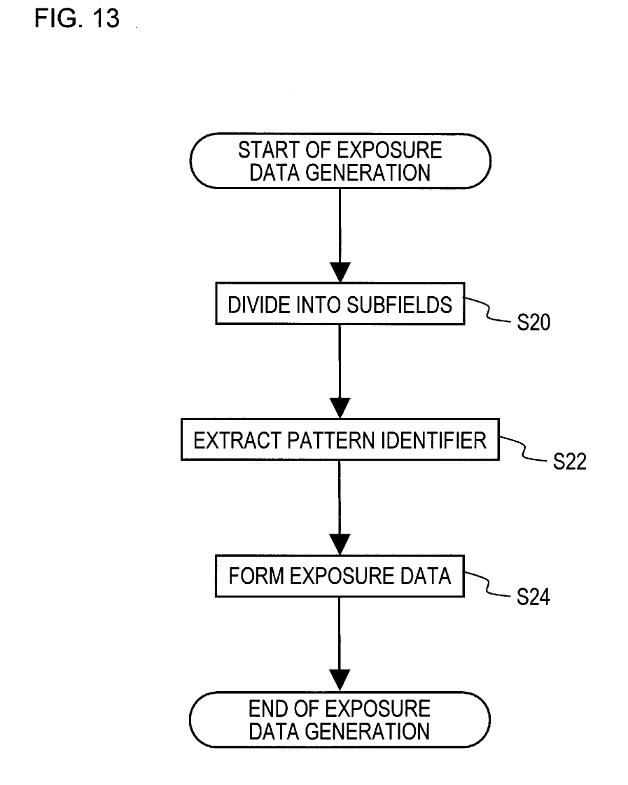

FIG. 13 is a flowchart of the exposure data generation step.

(i) Subfield Division Step (S20)

As illustrated in FIGS. 10 through 12, the computer 28 divides each layer pattern 54A, 54B, 54C of each layer 38a, 40a, 42a, which is included in the first wiring pattern 36 generated in the placement and routing step (S6), on the basis of each predetermined subfield 68 along division lines 64 (S20). In other words, the computer 28 divides the respective areas having the layer patterns 54A, 54B, 54C into the predetermined subfields 68.

As illustrated in FIG. 12 for example, each subfield 68 is an area whose one side located in an opposite direction to the first direction 56 contacts to the second track 50b, while another side located in the second direction 58 contacts to the first track 50a.

Further, the subfield 68 is an area having a predetermined size. Here, the predetermined size signifies that a size in the first direction 56 is a first integer multiple (for example, two-fold) of the period of the second tracks 50b, and a size in the second direction 58 is a second integer multiple (for example, two-fold) of the period of the first tracks 50a.

(ii) Pattern Identifier Extraction Step (S22)

Thereafter, the computer 28 extracts a pattern identifier of a subfield pattern corresponding to the divided layer pattern 54A (the divided pattern of the first wiring layer 38a) by referring to the pattern database 32. The subfield pattern is a pattern included in each area divided into the subfields.

Here, the subfield pattern is a graphic data registered (recorded) in the pattern database 32. Also, the subfield pattern is a registered pattern made correspondent with the pattern identifier. In regard to the registered pattern in the pattern database 32, description will be given later.

Similarly, the computer 28 extracts the pattern identifier of a subfield pattern corresponding to the divided layer pattern 54B (division pattern of the second wiring layer 40a) by referring to the pattern database 32.

At this time, the computer 28 searches the pattern database 32 using the divided layer pattern 54B as a key, so as to detect a subfield pattern matching (or coincident with) the divided layer pattern 54B. The computer 28 then extracts the pattern identifier made correspondent with the detected subfield pattern.

Further, by referring to the pattern database 32, the computer 28 extracts pattern identifiers corresponding to partial patterns that generate the layer pattern 54C of the via layer 42a among the divided layer patterns.

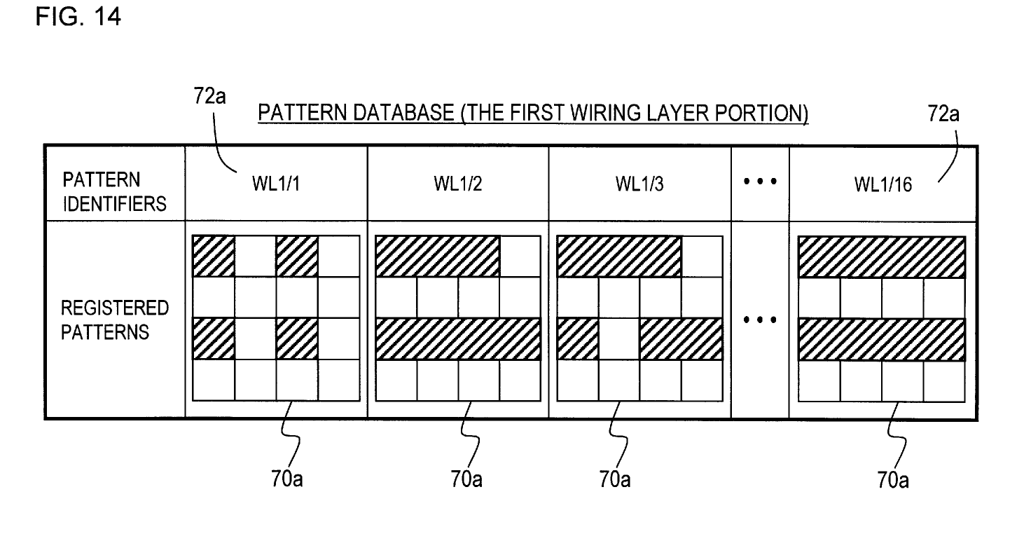

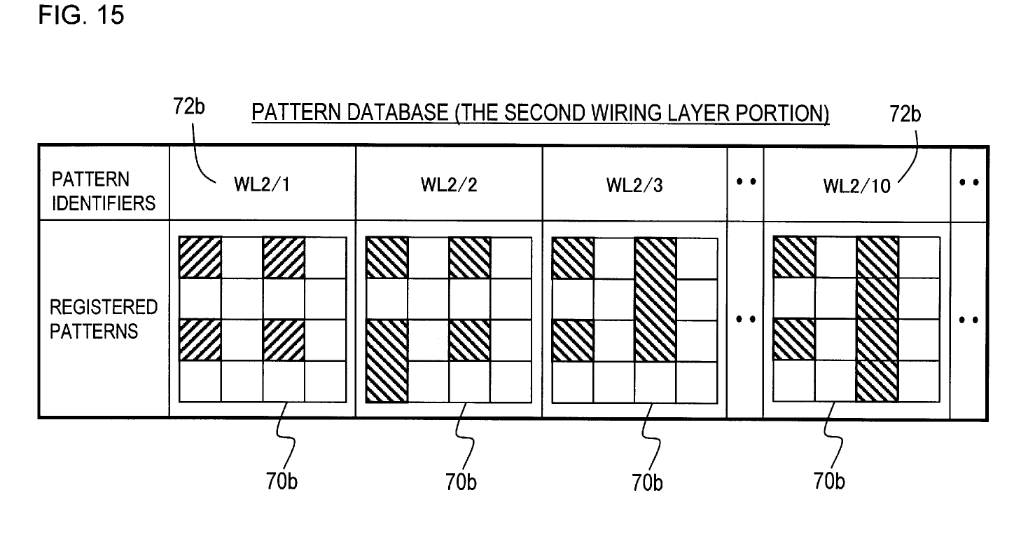

FIGS. 14 through 16 illustrate an example of the pattern database 32. FIG. 14 illustrates a portion of the pattern database 32 that corresponds to the first wiring layer 38. FIG. 15 illustrates a portion of the pattern database 32 that corresponds to the second wiring layer 40. FIG. 16 illustrates a portion of the pattern database 32 that corresponds to the via layer 42.

As illustrated in FIG. 14, in a portion of the pattern database 32 that corresponds to the first wiring layer, subfield patterns 70a and pattern identifiers 72a corresponding to the subfield patterns 70a are registered. Each subfield pattern 70a is a layer pattern of a first wiring layer included in a second multi-layer wiring pattern in which each layer pattern is generated in the subfield 68 according to the aforementioned wiring rule. In the pattern database 32, variations of the subfield patterns 70a (a plurality of mutually different subfield patterns 70a) are registered.

Similarly, in a portion of the pattern database 32 that corresponds to the second wiring layer (refer to FIG. 15) , subfield patterns 70b and pattern identifiers 72b corresponding to the subfield patterns 70b are registered. Each subfield pattern 70b is a layer pattern of the second wiring layer included in the second multi-layer wiring pattern. In the pattern database 32, variations of the subfield patterns 70b are registered.

Further, in a portion corresponding to the via layer (refer to FIG. 16), partial patterns 74, each forming one part of the subfield pattern of the via layer included in the second multi-layer wiring pattern, and pattern identifiers 72c thereof are registered. In the pattern database 32, variations of the partial patterns 74 are registered. Here, in the pattern database 32, the patterns (subfield patterns and partial patterns) are registered in a corresponding manner to the pattern identifiers thereof.

Each subfield pattern 70a illustrated in FIG. 14 has a width equal to two periods of the track in the first direction and the second direction, respectively. The number of combinations of the subfield patterns 70a formable in such an area is only 16 (=2⁴, the exponent 4 of 2 is the number of grid points included in each subfield). The same is applicable to the subfield patterns 70b in the second wiring layer.

The area of the block mask 12 attachable to the electron beam exposure apparatus 2 is limited. However, it is easy to provide blocks corresponding to such a small number of patterns in the block mask 12.

Also, in regard to the via layer, the number of combinations of the subfield patterns is only 16. Moreover, such layer patterns are formed of partial patterns 74 of which number of combinations is only 3 (=2²−1. The exponent of 2 is the number of grid points included in one track). It is easy to provide the block mask 12 with blocks corresponding to such a small number of patterns.

The number of variations in the subfield patterns depends on the size of the subfield 68. As described earlier, the subfield size in the first direction 56 is the first integer multiple (two-fold, for example) of the period of the second tracks 50b. Also, the subfield size in the second direction 58 is the second integer multiple (two-fold, for example) of the period of the first tracks 50a.

Preferably, the above first integer and the second integer are 2 or greater and 4 or smaller, respectively. If the first integer and the second integer are 1, number of exposure times becomes large so that throughput becomes low. On the other hand, if the first integer and the second integer are greater than 4, it becomes difficult to provide the entire blocks corresponding to the subfield patterns in the block area 24. Incidentally, when the first integer and the second integer are 3 and 4, respectively, the number of variations in the subfield patterns is 4,096 (=2^{3×4}).

Additionally, the pattern database may include block information. The block information indicates block positions (positions on the block mask) corresponding to the subfield patterns and the partial patterns.

(iii) Exposure Data Formation Step (S24)

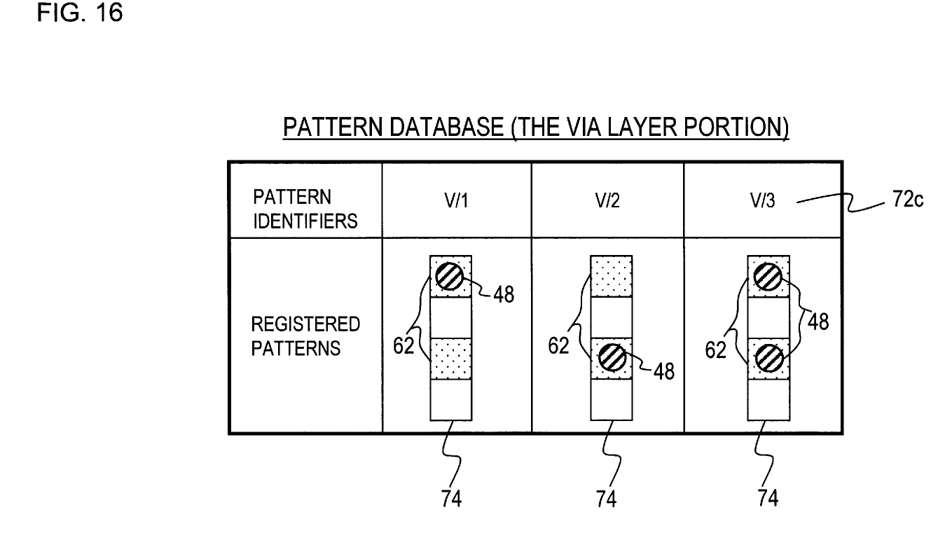

Finally, the computer 28 generates the exposure data. FIG. 17 is an example of exposure data 75 generated in the present step.

As illustrated in FIG. 17, the exposure data 75 includes pattern identifiers 72, which are extracted in the pattern identifier extraction step S22, and exposure positions 76 of the subfield patterns corresponding to the extracted pattern identifiers 72. The exposure positions 76 are respectively made correspondent with the pattern identifiers 72.

The exposure position 76 is, for example, the vertex coordinates of a block pattern transferred on the semiconductor substrate 16. The above coordinates are derived on the basis of the GDS data generated in the pattern data generation step (S8).

Further, the exposure data 75 includes the pattern identifiers 72a of the cell patterns disposed on the gate layer etc. and the exposure positions 76a thereof. The pattern identifiers 72a are recorded on the standard cell library.

The computer 28 generates a pattern neither registered in the pattern database 32 nor in the standard cell library 42, using the VSB method. The exposure data 75 also include pattern exposure data (not illustrated) generated by the VSB method.

Now, the block 24 corresponding to the subfield patterns is provided in the block area 22 on a layer-by-layer basis (refer to FIGS. 2 and 3). The same is applicable to the block 22 corresponding to the partial patterns.

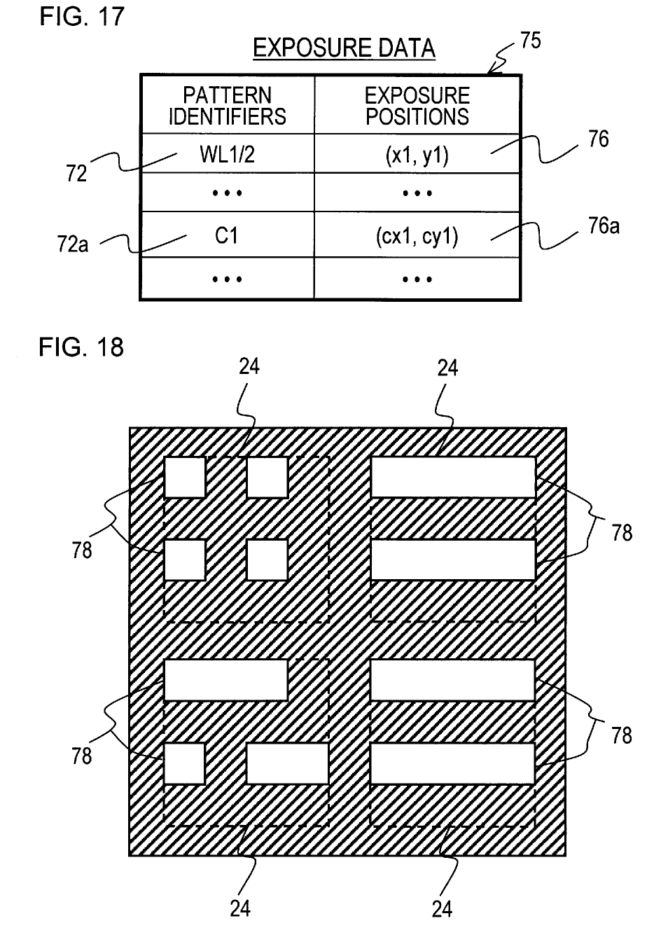

FIG. 18 is a partial enlarged view of the block area 22 corresponding to the first wiring layer. In each block 24, apertures 78 corresponding to the subfield patterns 70a, 70b or the partial patterns 74 are provided. Here, FIG. 18 illustrates the blocks corresponding to the first wiring layer. Further, in the block area 22, a block (not illustrated) corresponding to the cell pattern in the standard cell library 34 is also provided.

The exposure control apparatus of the electron beam exposure apparatus 2 includes a block position database, having block positions (positions on the block mask) corresponding to the registered patterns in the pattern database 32 and the pattern identifiers of the above registered patterns.

The exposure control apparatus of the electron beam exposure apparatus 2 searches the block position database, using the pattern identifiers 72, 72a included in the exposure data 75 as keys, so as to detect the block positions corresponding to the pattern identifiers 72, 72a.

Based on the detected block positions and exposure positions 76, 76a included in the exposure data 75, the electron beam exposure apparatus 2 transfers the IC layout pattern, generated in the placement and routing step (S6), on a layer-by-layer basis.

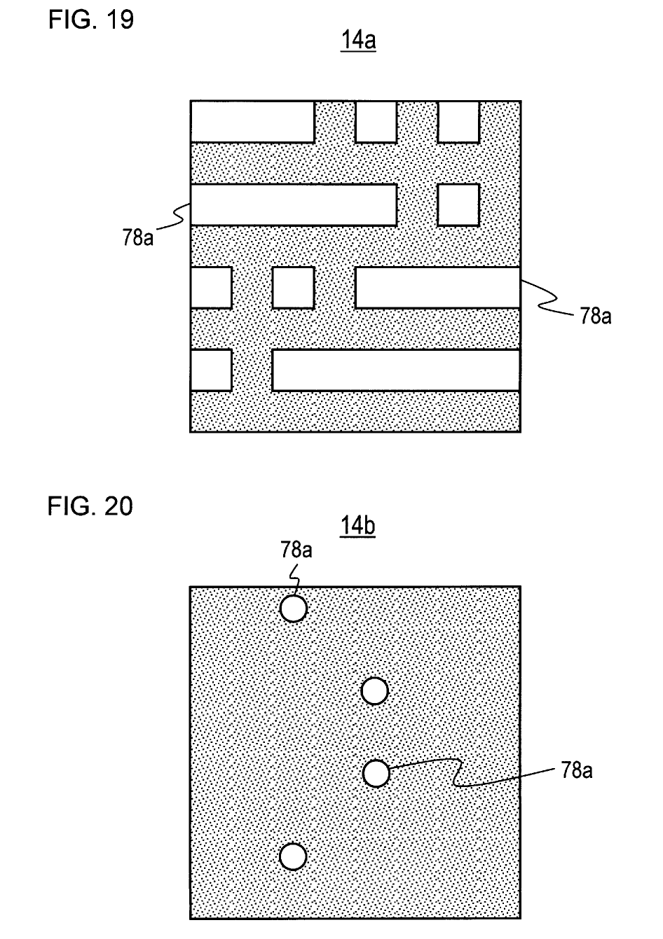

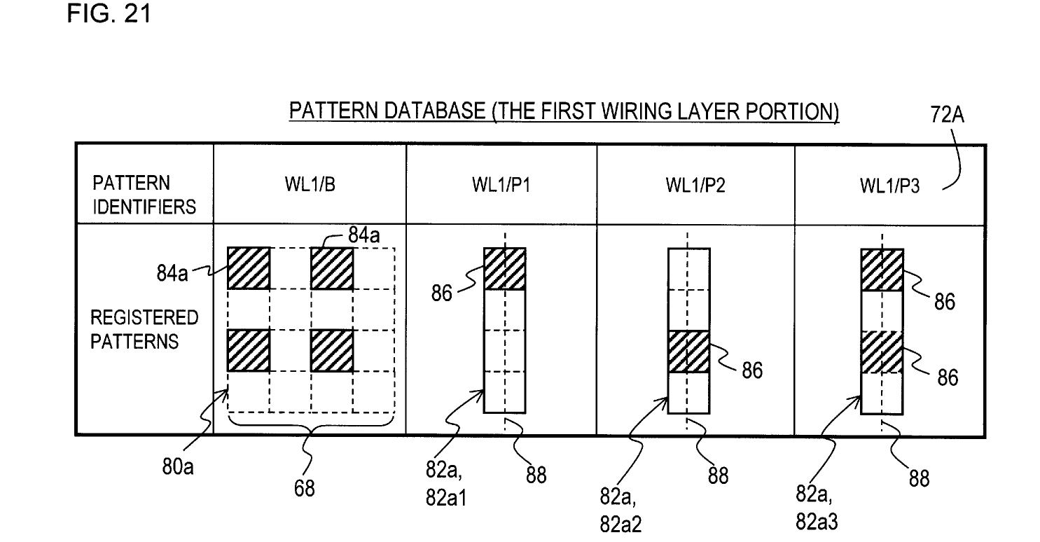

FIG. 19 is a plan view of a resist film 14a having the layer pattern 54A of the first wiring layer 38a (refer to FIG. 10) transferred thereon. FIG. 20 is a plan view of a resist film 14b having the layer pattern of the via layer 42 (refer to FIG. 12) transferred thereon. The resist films illustrated in FIGS. 19, 20 are formed of positive-type resists. Accordingly, apertures 78a corresponding to the layer patterns of the respective layers are formed on the resist films 14a, 14b.

As such, according to the present embodiment, it is possible to form a desired wiring pattern using a block mask. By this, the throughput of the electron beam exposure relative to the wiring pattern is improved.

In the examples described above, the partial patterns of the via layer are registered in the pattern database 32. However, it is also possible to register the subfield patterns of the via layer in the pattern database 32.

In the above case, in the pattern identifier extraction step (S22), the computer 28 extracts pattern identifiers corresponding to the divided via layer patterns. The computer 28 then forms exposure data having the extracted pattern identifiers of the via layer and the exposure positions thereof.

As illustrated in FIG. 12, the number of the via patterns included in the subfield 68 is not large. Therefore, it may be possible to form the layer pattern of the via layer by using the VSB method.

### Embodiment 2

The larger the size of the subfield 68 is, the larger the area rendered by one time exposure is, and accordingly, the smaller the number of exposure times to transfer the layout pattern to the resist film is. As a result, the throughput of the electron beam exposure is improved.

On the other hand, when the size of the subfield 68 becomes large, the number of subfield patterns increases. As a result, it becomes difficult to provide blocks corresponding to the entire subfield patterns in one block mask.

According to the present embodiment, in regard to the layer pattern of the first wiring layer 38a, the number of blocks is reduced by use of partial patterns, similar to the case of the via layer. The same is applicable to the layer pattern of the second wiring layer 40a. Here, the present embodiment has a common portion to the first embodiment, and the description on the common portion will be omitted.

Pattern Database

FIG. 21 illustrates an example of a pattern database 32 according to the present embodiment. In FIG. 21, a portion of the pattern database 32 corresponding to the first wiring layer 38a is illustrated.

In the portion of the pattern database 32 corresponding to the first wiring layer, there are registered partial patterns 80a, 82a of the first wiring layer (wiring layer of the second multi-layer wiring pattern) and the pattern identifiers 72A corresponding to the above partial patterns. The same is applicable to the portions corresponding to the second wiring layer and the via layer.

As illustrated in FIG. 21, the partial patterns of the first wiring layer includes a first base pattern 80a and a plurality of first wiring formation patterns 82a. Here, the partial patterns 80a, 82a of the first wiring layer are partial patterns forming the subfield pattern 70a of the first wiring layer (subfield pattern to be formed on the first wiring layer) included in the second multi-layer wiring pattern.

As described in the embodiment 1, the second multi-layer wiring pattern is a multi-layer wiring pattern formed in the subfield 68 according to a predetermined wiring rule (for example, the standard wiring rule).

As illustrated in FIG. 21, the first base pattern 80a is a pattern having first isolated patterns 84a disposed at the respective grid points in the subfield 68. The first wiring formation patterns 82a are partial patterns having connection patterns 86 disposed between the first isolated patterns 84a (or between the outer circumference of the first base pattern 80a and the first isolated patterns 84a).

The first wiring formation pattern 82a includes a connection pattern 86 arrayed on a center line (straight line) 88. Preferably, the direction of the center line (straight line) 88 is either the first direction 56 or the second direction 58.

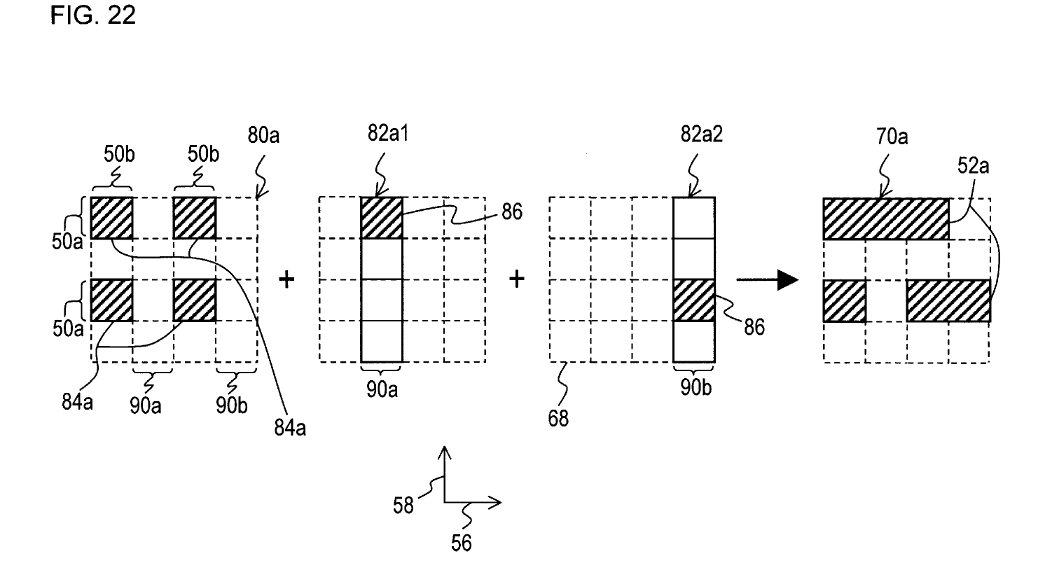

FIG. 22 is a diagram illustrating a rule to form the subfield pattern 70a corresponding to the first wiring layer, from the first base pattern 80a and the plurality of first wiring formation patterns 82a1, 82a2. In FIG. 22, the first tracks 50a and the second tracks 50b are depicted with broken lines.

As illustrated in FIG. 22, the first wiring formation pattern 82a1 is disposed in an area 90a located at the leftmost of inter-track areas 90a, 90b sandwiched by the second tracks 50b in the first base pattern 80a.

Further, the first wiring formation pattern 82a2 is disposed in the area 90b located second from the left among the inter-track areas 90a, 90b. At this time, the first wiring formation pattern 82a2 is disposed between the first isolated patterns 84a and the outer circumference of the first base pattern 80a.

Thus, the first isolated patterns 84a are connected, and then two stripe patterns 52a are formed. In other words, the subfield pattern 70a of the first wiring layer is formed by the first base pattern 80a and the first wiring formation patterns 82a1, 82a2.

In the example illustrated in FIG. 22, the extension directions of the first wiring formation patterns 82a1, 82a2 (that is, the direction of the center 88) are the second direction 58. Accordingly, the first stripe patterns 52a extending to the first direction 56 are formed by the plurality of first wiring formation patterns.

The first wiring formation patterns 82a1, 82a2 may extend to the first direction 56. In that case, the first stripe patterns 52a are formed by one first wiring formation pattern.

When the width of the subfield 68 equals two periods of the track, the first wiring formation patterns 82a1-82a3 are only three patterns as illustrated in FIG. 21. Also, the first base pattern 80a is only one pattern as illustrated in FIG. 21.

Accordingly, by use of four (=3+1) partial patterns, it is possible to form entire 16 variations of subfield patterns (subfield patterns of the first wiring layer) to be formed in the subfield 68. Thus, according to the present embodiment, the number of blocks to be provided in the block mask may be reduced further, as compared to the embodiment 1. Alternatively, the number of exposure times may be reduced by the increase of the subfield size.

When the size of the first wiring formation pattern in the longitudinal direction (for example, the second direction 58) is 16-fold larger than the period of the first track 50a, the number of combinations of the first wiring formation patterns becomes 65,536 (=2¹⁶).) A block width corresponding to the first wiring formation pattern is as small as 40 nm or of that order, for example. Therefore, it is easy to provide approximately 65,536 combinations of blocks 24 in the block area 22.

In other words, if one side of the subfield 68 (for example, a side extending to the second direction) is approximately 16-fold larger than the period of an intersecting track (for example, the first track), the number of the first wiring formation patterns do not become too large. On the other hand, if the one side of the subfield 68 equals one track period, the number of exposure times becomes too large. Incidentally, the number of the first wiring formation patterns remains the same if the size of the other side of the subfield 68 is set larger.

Therefore, preferably, one side of the subfield 68 is 2-fold or greater and 16-fold or smaller than the period of the intersecting track. Preferably, one side of the subfield 68 is 5-fold or greater and 10-fold or smaller than the period of the intersecting track.

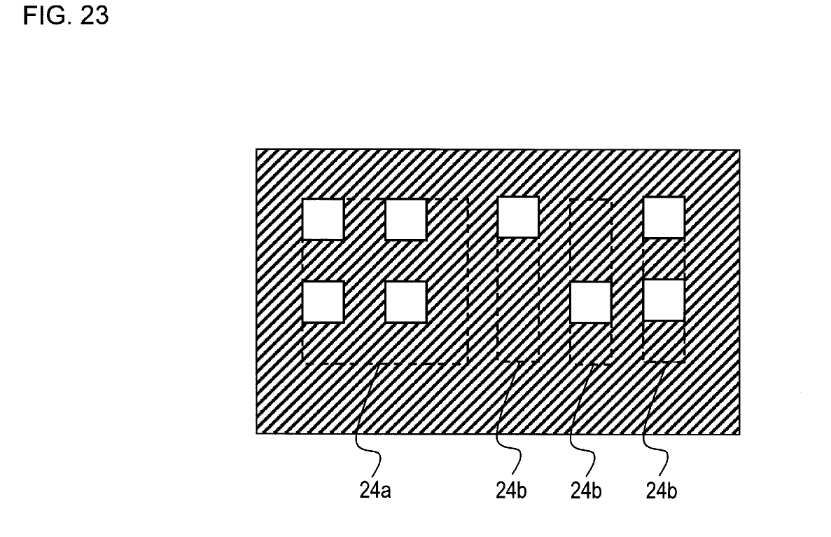

FIG. 23 is a partial enlarged view of the block area having blocks 24a, 24b corresponding to the partial patterns depicted in FIG. 21. In FIG. 23, there are illustrated a block 24a corresponding to the first base pattern 80a and three blocks 24b corresponding to the first wiring formation patterns 82a.

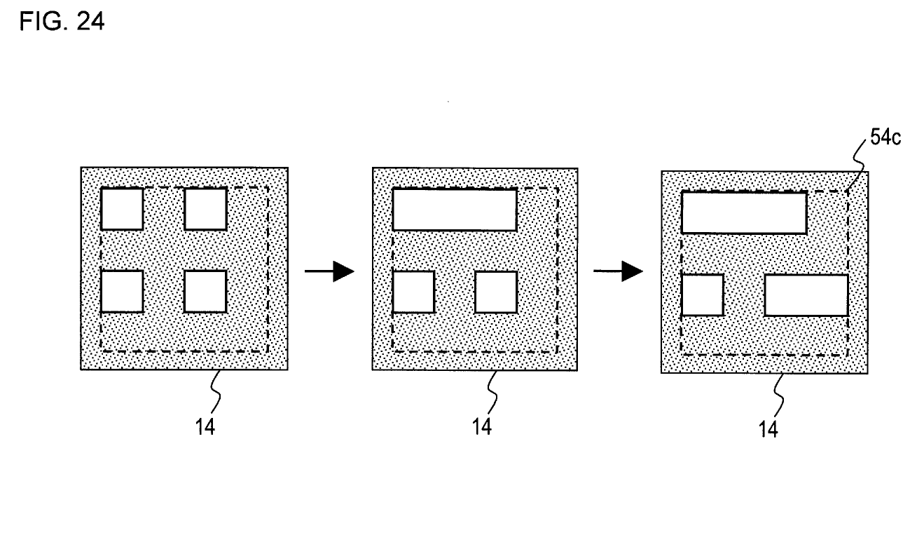

FIG. 24 is a diagram illustrating a process to transfer the subfield pattern 70a to the resist film 14. First, the first base pattern 80a is transferred to the resist film 14. Next, the first wiring formation pattern 82a1 corresponding to the pattern identifier WL/P1 is transferred to the resist film 14. Finally, the first wiring formation pattern 82a2 corresponding to the pattern identifier WL/P2 is transferred, and thus, the subfield pattern 70a is transferred to the resist film 14.

Also, in the pattern database 32, partial patterns of the second wiring layer and pattern identifiers corresponding to these partial patterns are registered.

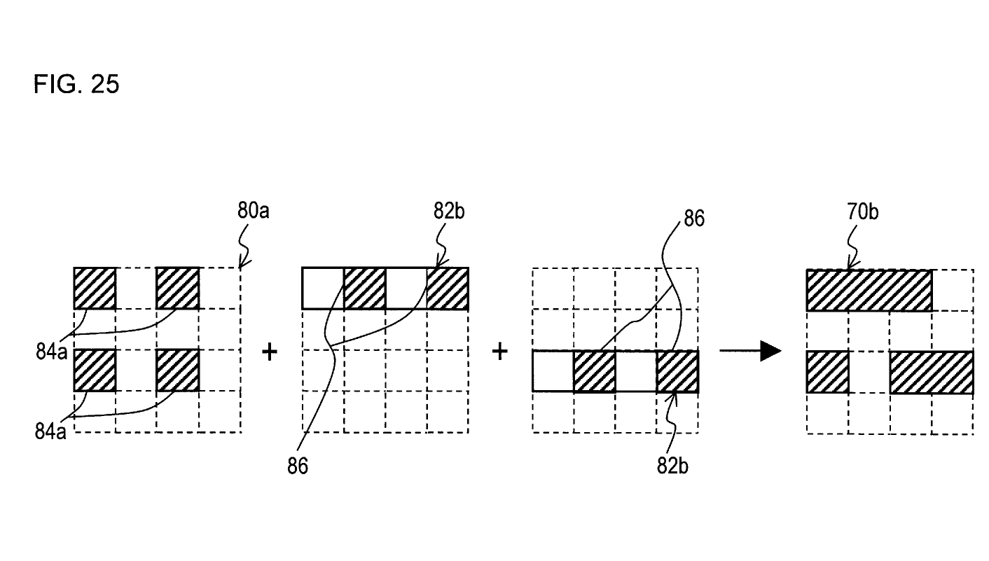

FIG. 25 is a diagram illustrating the partial patterns of the second wiring layer. Similar to the partial patterns of the first wiring layer, the partial patterns of the second wiring layer are partial patterns forming the subfield pattern 70b of the second wiring layer (i.e. the subfield pattern generated in the second wiring layer) included in the second multi-layer wiring pattern which is formed on the subfield.

As illustrated in FIG. 25, the partial patterns of the second wiring layer are the first base pattern 80a and a plurality of wiring formation patterns 82b.

The first base pattern 80a is the base pattern described by reference to FIG. 22. The second wiring formation pattern 82b is a partial pattern having the connection patterns 86 to be disposed between the first isolated patterns 84a (or between the outer circumference of the first base pattern 80a and the first isolated patterns 84a).

Also, in the pattern database 32, the partial patterns of the via layer and the pattern identifiers corresponding to these partial patterns are registered. The partial patterns of the via layer are partial patterns forming the subfield pattern of the via layer (the subfield pattern generated in the via layer) included in the second multi-layer wiring pattern.

The partial patterns of the via layer are the partial patterns 74 depicted in FIG. 16 (which is referred to as “via layer formation pattern” hereafter). Namely, the partial patterns forming the via layer are patterns having the via patterns 48 disposed at the grid points 62.

As illustrated in FIGS. 16 and 21, the first wiring formation pattern, the second wiring formation pattern and the via layer formation pattern are patterns narrower than the subfield 68. However, the first wiring formation pattern, the second wiring formation pattern and the via layer formation pattern are patterns each extending in one direction (the second direction 58, for example) 2-fold or longer than the period of a track (the first track 50a, for example) extending in the other direction (the first direction 56, for example).

Exposure Data Generation Step (S10)

The exposure data generation step according to the present embodiment is substantially identical to the exposure data generation step of the embodiment 1. However, the pattern identifier extraction step (S22) is partially different.

In the embodiment 1, the pattern identifiers of the subfield patterns corresponding to the layer pattern of the wiring layer divided in the subfield division step (S20) are extracted.

In contrast, according to the present embodiment, the pattern identifiers of the partial patterns corresponding to the divided entire layer patterns (the first wiring layer pattern, the second wiring layer pattern and the via layer pattern) are extracted. Other steps are substantially identical to the embodiment 1.

### Embodiment 3

In the wiring rule of the embodiment 1 and 2, the first stripe pattern 52a disposed on the first wiring layer and the second stripe pattern 52b disposed on the second wiring layer are connected by one via pattern. In contrast, according to the present embodiment, the first stripe pattern 52a and the second stripe pattern 52b are connected by a plurality (typically, 2) of via patterns. The present embodiment has portions common to the embodiment 1 and 2. Therefore, descriptions on the common portions will be omitted.

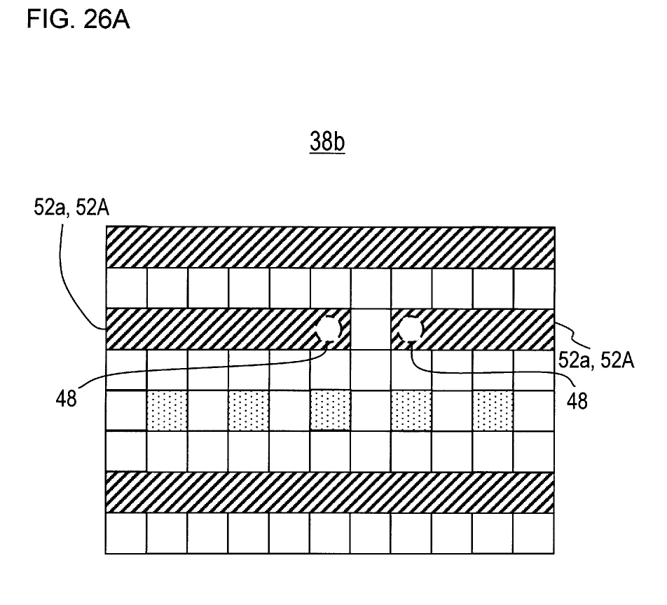

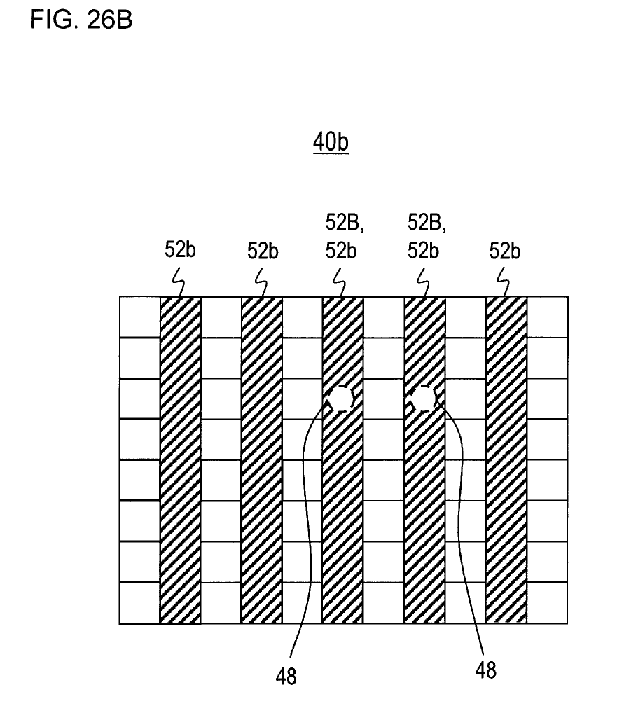

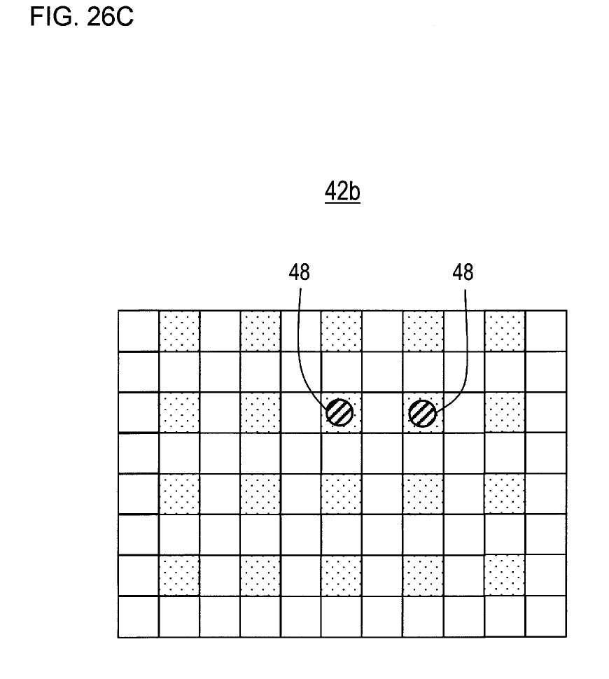

FIG. 26A illustrates an example of a first wiring layer 38b in a state that each first stripe pattern 52a and each second stripe pattern 52b are connected by one via pattern 48. The first wiring layer 38b is a layer pattern of the multi-layer wiring pattern generated according to a netlist and a predetermined wiring rule (for example, standard wiring rule).

In FIG. 26A, the via patterns 48 formed on the via layer are depicted in an outlined manner, for reference sake. The same is applicable to the following FIG. 26B. The layer patterns depicted in FIGS. 26A through 26C are layer patterns generated in a subfield.

FIG. 26B illustrates an example of a second wiring layer 40b in a state that each first stripe pattern 52a and each second stripe pattern 52b are connected by one via pattern 48. Also, FIG. 26C illustrates an example of a via layer 42b in a state that each first stripe pattern 52a and each second stripe pattern 52b are connected by one via pattern 48.

Wiring Rule

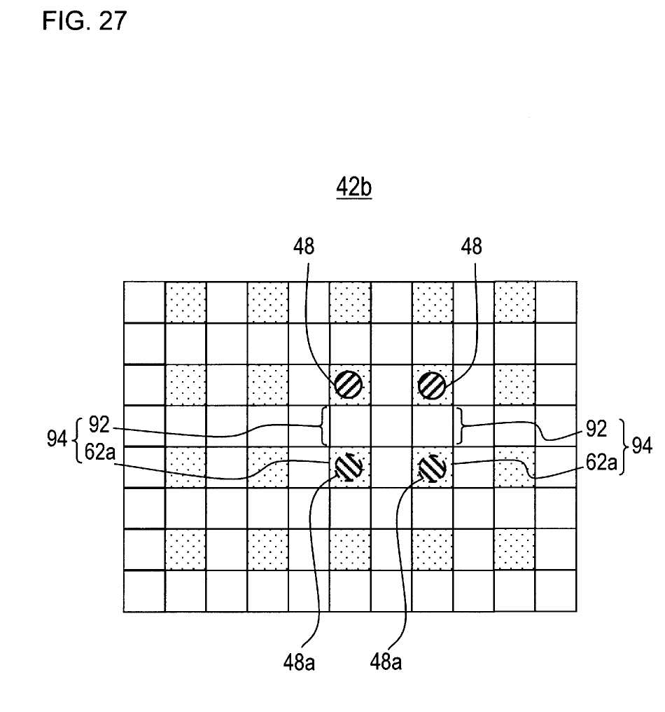

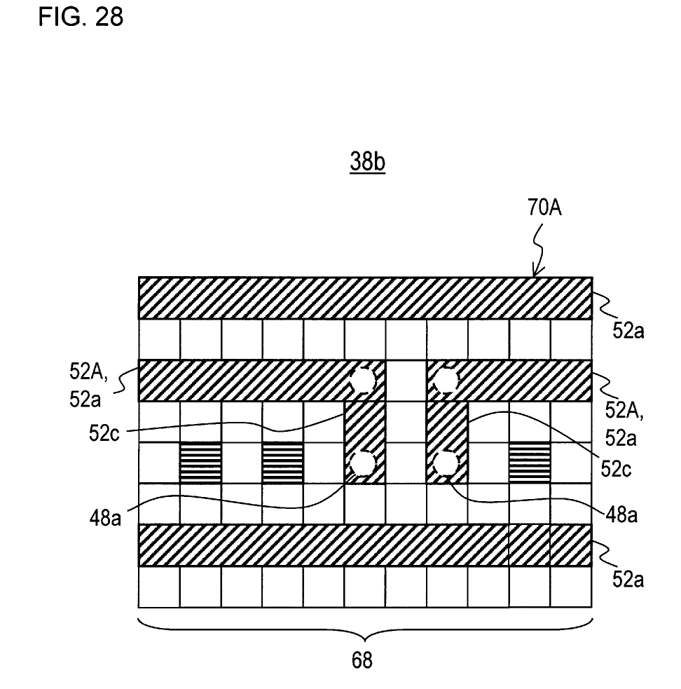

FIGS. 27 and 28 are explanation diagrams of the wiring rule according to the present embodiment. According to the wiring rule of the present embodiment, first, a procedure specified by the wiring rule of the embodiment 1 is executed. As a result, the layer patterns as illustrated in FIGS. 26A through 26C are generated

Further, according to the wiring rule of the present embodiment, auxiliary via patterns 48a are also disposed in the via layer 42b, at grid points adjacent to the via patterns 48, as illustrated in FIG. 27.

Here, each second stripe pattern 52B (refer to FIG. 26B) is connected to each auxiliary via pattern 48a. On the other hand, the first stripe patterns 52A are not connected to the auxiliary via patterns 48a (refer to FIG. 26A).

Next, as illustrated in FIGS. 27 and 28, third stripe patterns 52c are disposed in rectangular areas 94 including areas 92, which are located between the first stripe patterns 52A and grid points 62a in which the auxiliary vias 48a are disposed, and the grid points 62a. Here, as is apparent from the above description, the first stripe patterns 52A are stripe patterns not connected to the auxiliary via patterns 48a, among the first stripe patterns 52A and the second stripe patterns 52B to be connected by the via patterns 48.

By the intermediary of the third stripe patterns 52c, the first stripe patterns 52A are also connected to the auxiliary via patterns 48a. In other words, each first stripe pattern 52A and each second stripe pattern 52B are connected by the plurality of via patterns.

Partial Patterns

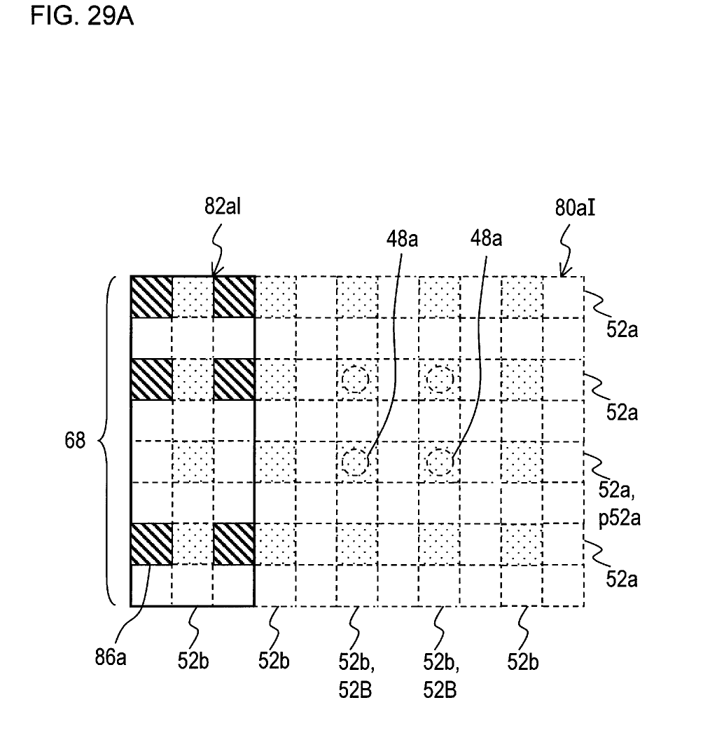

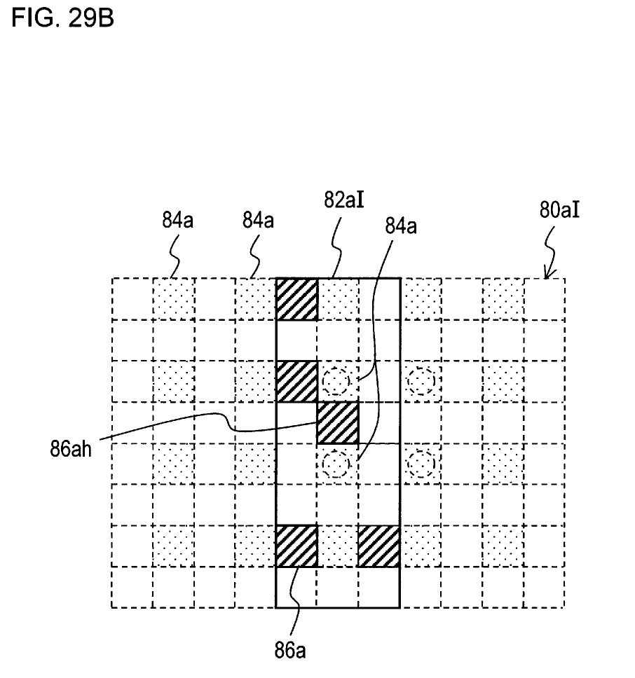

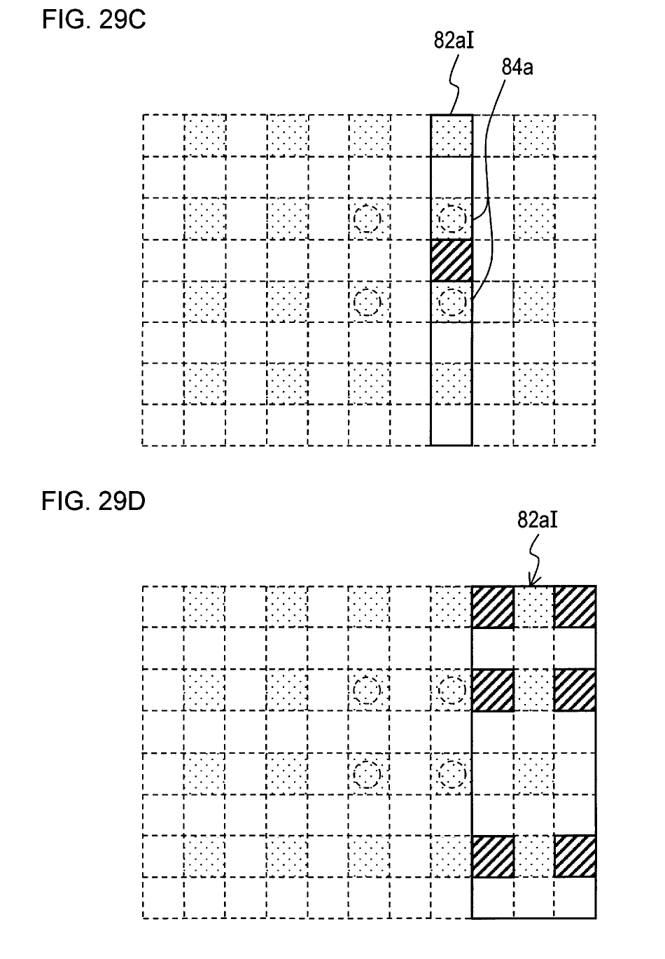

In the pattern database 32 of the present embodiment, partial patterns forming the subfield pattern are registered, similar to the embodiment 2. FIGS. 29A through 29D are explanation diagrams of the partial patterns forming the subfield pattern (refer to FIG. 26A) of the first wiring layer in the present embodiment.

Now, it is assumed that a subfield pattern 70A illustrated in FIG. 28 is generated in the subfield 68. The subfield pattern 70A is a subfield pattern of the first wiring layer.

The partial patterns forming the subfield pattern 70A are a first base pattern 80aI and a plurality of first wiring formation patterns 82aI (refer to FIGS. 29A to 29D). As illustrated in FIGS. 29A to 29D, the subfield pattern 70A is formed by successively overlaying the first wiring formation patterns 82aI on the first base pattern 80aI.

The first wiring formation pattern 82aI illustrated in FIGS. 29A and 29D are patterns forming the first stripe patterns 52a.

The first wiring formation pattern 82aI illustrated in FIG. 29B is a pattern forming the first stripe patterns 52a and the third stripe patterns 52c (refer to FIG. 28). Here, each third stripe pattern 52c is formed by connecting a pair of isolated patterns 84a directed to the second direction 58, using a connection pattern 86ah.

The first wiring formation pattern 82aI illustrated in FIG. 29C is a pattern forming the third stripe pattern 52c.

The first wiring formation pattern 82aI illustrated in FIGS. 29A, 29B and 29D has a width 1.5-fold as large as the period of the second tracks 52b (the first wiring formation pattern 82aI includes a pair of second tracks 52b). As such, by enlarging the width of the wiring formation pattern, it is possible to reduce the number of blocks corresponding to the first wiring formation pattern.

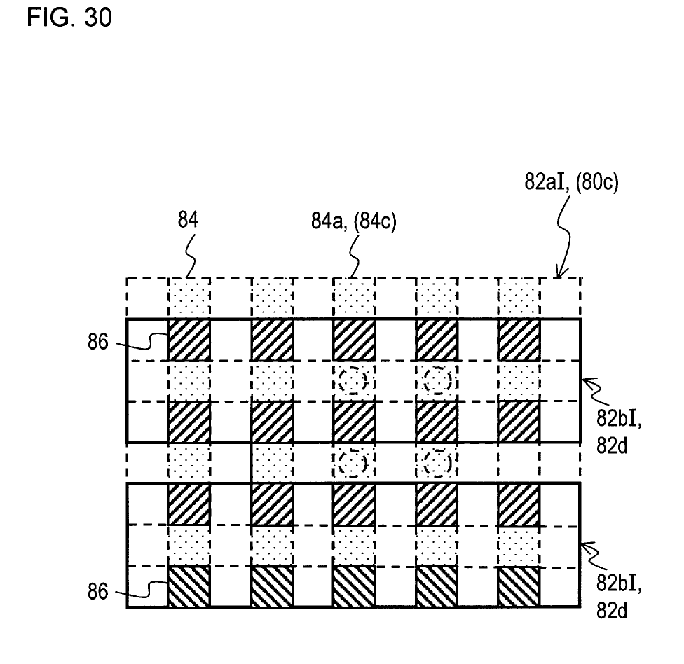

FIG. 30 is an explanation diagram of the partial patterns forming the subfield pattern of the second wiring layer 40b (refer to FIG. 26B). These partial patterns are a first base pattern 80aI and a plurality of second wiring formation patterns 82bI.

The first base pattern 80aI is the base pattern described by reference to FIG. 29A. Each second wiring formation pattern 82bI is a pattern having a connection pattern 86 to be disposed between the first isolated patterns 84 (or between the outer circumference of the first base pattern 80aI and the first isolated pattern 84). Additionally, the subfield pattern of the second wiring layer illustrated in FIG. 26B does not include any auxiliary via pattern. However, the subfield pattern of the second wiring layer may also include auxiliary via patterns.

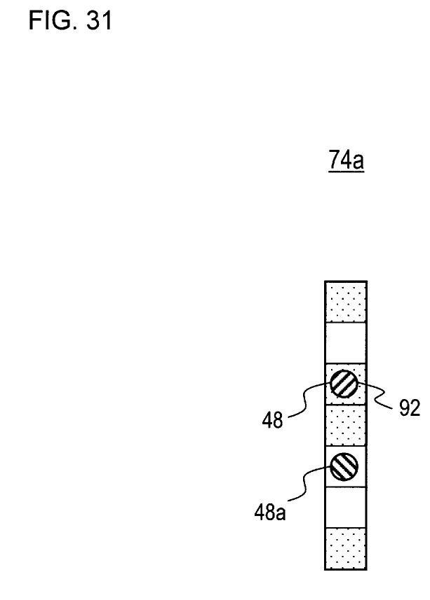

FIG. 31 is an example of partial pattern forming the subfield pattern of the via layer (refer to FIG. 27). This partial pattern 74a includes the via pattern 48 and the auxiliary via pattern 48a. The subfield pattern of the via layer is formed by disposing the above partial pattern 74a on the second track B of the subfield 68 (refer to FIG. 29A).

Now, when the first wiring formation pattern includes a plurality of tracks, the variations of the first wiring formation patterns increase. This may produce a case that the blocks 24 corresponding to the first wiring formation pattern may not be disposed in the block area 22. The same is applicable to the second wiring formation pattern.

In such a case, in the aforementioned wiring rule, it is possible to limit a grid point, on which the auxiliary via pattern is disposed, to a grid point included in a portion of tracks, among the first tracks 52a. By this, the variations of the first wiring formation pattern are reduced, and the increase of the blocks is restrained accordingly.

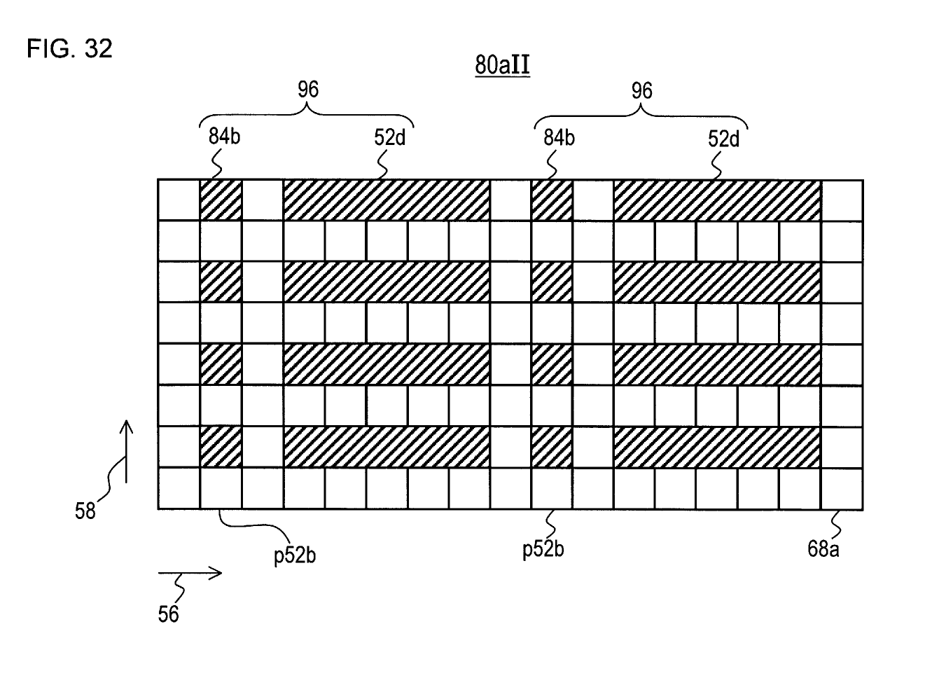

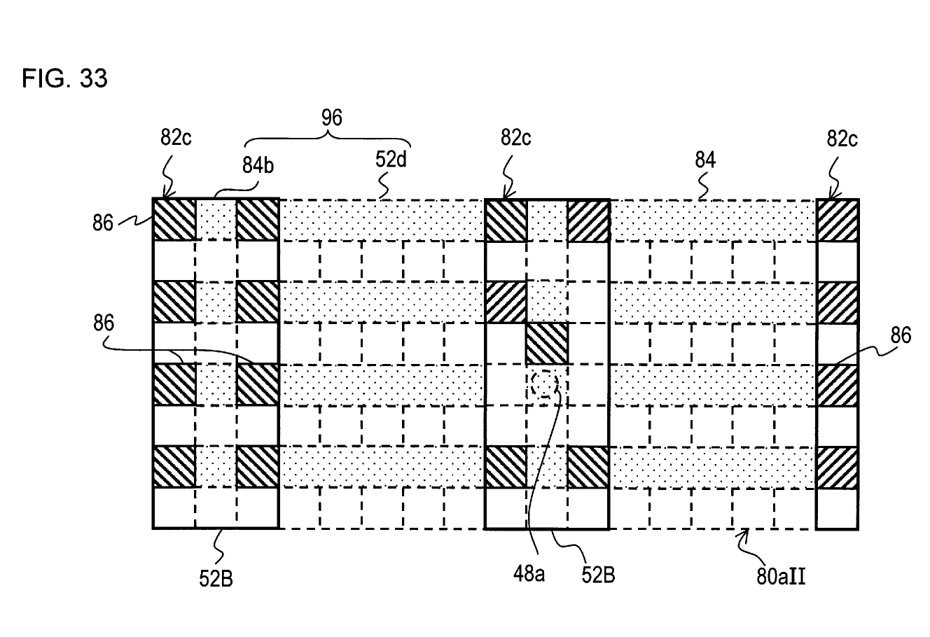

Alternatively, a grid point on which the auxiliary via pattern 48a is disposed may be limited to a grid point included in a portion of tracks among the second track 52b. FIG. 32 is a diagram illustrating an exemplary deformation of the base pattern (a second base pattern) for use in the above case. FIG. 33 is a diagram illustrating third wiring formation patterns 82c corresponding to a second base pattern 80aII. In FIG. 33, the second base pattern 80aII is illustrated with broken lines.

As illustrated in FIG. 33, the subfield pattern of the first wiring layer is formed by overlaying the third wiring formation patterns 82c on the second base pattern 80aII.

As illustrated in FIG. 32, the second base pattern 80aII is a base pattern in which pattern pairs 96 each having a fourth stripe pattern 52d and a second isolated pattern 84b are periodically disposed in both the first direction 56 and the second direction 58. The fourth stripe pattern 52d is a stripe pattern that extends to the first direction 56 and includes grid points at both ends. The second isolated pattern 84b is an isolated pattern disposed on a grid point that is located adjacent to the fourth stripe pattern 52d on the extended line of the fourth stripe pattern 52d.

As illustrated in FIG. 33, the third wiring formation pattern 82c is a pattern having connection patterns 86 each disposed between the fourth stripe pattern 52d and the second isolated pattern 84b (or between the outer circumference of the second base pattern 80aII and the pattern pair 96).

Using the second base pattern 80aII and the third wiring formation pattern 82c, it is possible to limit a track, having a grid point on which the auxiliary via pattern 48a is disposed, to a portion of the second tracks 52b (track portion 52B).

The partial patterns forming the subfield of the second wiring layer include a third base pattern and a fourth wiring formation pattern. The third base pattern is substantially identical to the first base pattern 80aI described by reference to FIG. 30. Also, the fourth wiring formation pattern is substantially identical to the second wiring formation pattern 82bI described by reference to FIG. 30.

More specifically, a third base pattern 80c includes third isolated patterns 84c disposed at the respective grid points in the subfield. The fourth wiring formation pattern includes connection patterns 86 disposed between the third isolated patterns (or between the outer circumference of the third base pattern 80c and the third isolated patterns 84c).

In the present embodiment, the first wiring pattern and the second wiring pattern are connected with two vias. However, it may be possible to connect the first wiring pattern and the second wiring pattern with three or more vias. In that case, still other auxiliary via is disposed at the grid point adjacent to the grid point on which the auxiliary via is disposed.

Now, there are cases that the wiring layer division of the multi-layer wiring pattern produces a so-called line-and-space structure. To cope with such a case, it may be possible to register in the pattern database 32 a line-and-space structure pattern (hereafter referred to as “L&S pattern”) and the pattern identifier thereof.

When the L&S pattern is extracted in the subfield division step (S20), the computer 28 extracts a pattern identifier corresponding to the L&S pattern in the pattern identifier extraction step (S22), and generates exposure data based on the extracted pattern identifier.

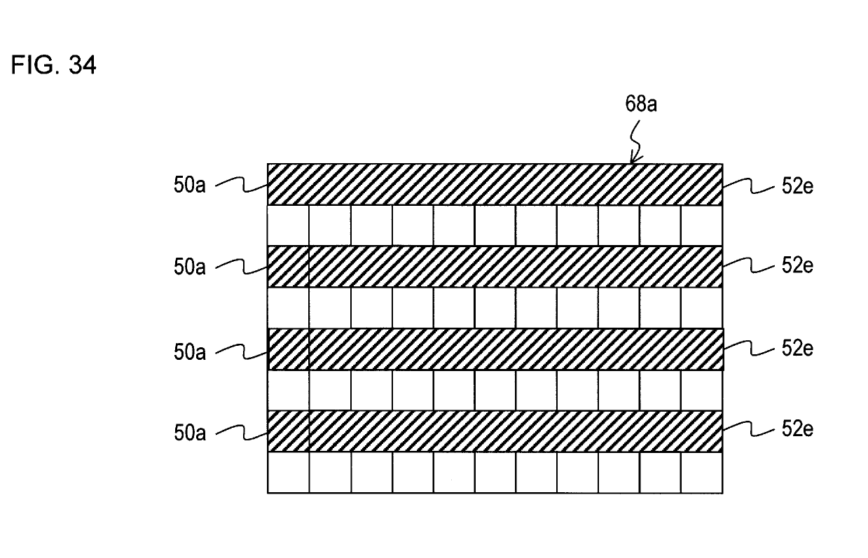

FIG. 34 is an example of the L&S pattern. As illustrated in FIG. 34, the L&S pattern is a pattern having stripe patterns 52e extending from one end of a subfield 68a to the other end. In the example illustrated in FIG. 34, the stripe patterns 52e are disposed on the first tracks 50a. However, the stripe patterns 52e may be disposed on the second tracks 50b.

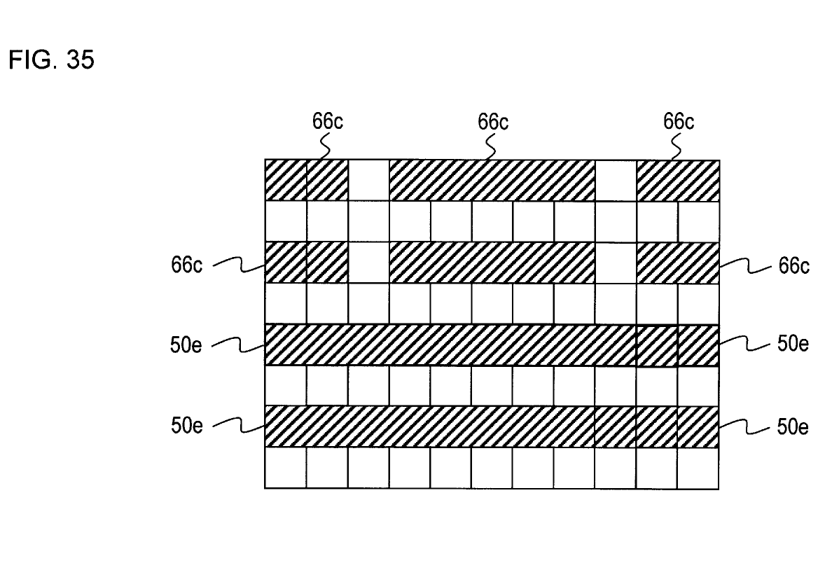

FIG. 35 is an exemplary deformation of the L&S pattern. In the exemplary deformation illustrated in FIG. 35, dummy patterns 66c are disposed on the tracks on which no line pattern is disposed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An exposure data generation method comprising:
generating a first multi-layer wiring pattern including a plurality of wiring layers according to a netlist and a wiring rule;
dividing a layer pattern of each layer included in the generated first multi-layer wiring pattern by a subfield;
by referring to a pattern database in which a subfield pattern of a wiring layer, included in a second multi-layer wiring pattern generated in the subfield according to the wiring rule, and a pattern identifier corresponding to the subfield pattern are registered, extracting the pattern identifier of the subfield pattern corresponding to the divided layer pattern of the first multi-layer wiring pattern; and
generating exposure data including the extracted pattern identifier and an exposure position of the subfield pattern corresponding to the extracted pattern identifier.

2. The exposure data generation method according to claim 1,
wherein the first multi-layer wiring pattern and the second multi-layer wiring pattern further include a via layer sandwiched by the plurality of wiring layers, and
wherein, in the pattern database, partial patterns forming a subfield pattern of the via layer included in the second multi-layer wiring pattern and pattern identifiers corresponding to the partial patterns are registered, and
in extracting, the pattern identifiers of the partial patterns corresponding to a pattern of the via layer among the divided layer patterns of the first multi-layer wiring pattern are extracted, and
in generating the exposure data, the exposure data including the extracted pattern identifiers of the partial patterns and exposure positions of the partial patterns are generated.

3. The exposure data generation method according to claim 1,
wherein the wiring rule is a rule to generate a multi-layer wiring pattern including a first wiring layer, a second wiring layer, and a via layer disposed between the first wiring layer and the second wiring layer, and
wherein the multi-layer wiring pattern to be generated according to the wiring rule is generated by:
in the first wiring layer, generating a layer pattern of the first wiring layer by disposing a first stripe pattern on a first track extending to a first direction;
in the second wiring layer, generating a layer pattern of the second wiring layer by disposing a second stripe pattern on a second track extending to a second direction intersecting with the first direction; and
in the via layer, connecting the first stripe pattern to the second stripe pattern by disposing a via pattern at a grid point at which the first track three-dimensionally intersects with the second track.

4. The exposure data generation method according to claim 3,
wherein the multi-layer wiring pattern to be generated according to the wiring rule is generated by:
further disposing a dummy pattern at the grid point not included in the first stripe pattern among the grid point included in the first wiring layer; and
disposing a dummy pattern at the grid point not included in the disposed second stripe pattern among the grid point included in the second wiring layer.

5. An exposure data generation method comprising:
generating a first multi-layer wiring pattern including a plurality of wiring layers according to a netlist and a wiring rule;
dividing a layer pattern of each layer included in the generated first multi-layer wiring pattern on by a subfield;
by referring to a pattern database in which partial patterns forming a subfield pattern of each layer, included in a second multi-layer wiring pattern generated in the subfield according to the wiring rule, and pattern identifiers corresponding to the partial patterns are registered, extracting the pattern identifiers of the partial patterns corresponding to the divided layer pattern of the first multi-layer wiring pattern; and
generating exposure data including the extracted pattern identifiers and exposure positions of the partial patterns corresponding to the extracted pattern identifiers.

6. The exposure data generation method according to claim 5,
wherein the wiring rule is a rule to generate a layer pattern of each layer included in a multi-layer wiring pattern including a first wiring layer, a second wiring layer and a via layer disposed between the first wiring layer and the second wiring layer, and
wherein the multi-layer wiring pattern to be generated according to the wiring rule is generated by:
in the first wiring layer, generating a layer pattern of the first wiring layer by disposing a first stripe pattern on a first track extending to a first direction;
in the second wiring layer, generating a layer pattern of the second wiring layer by disposing a second stripe pattern on a second track extending to a second direction intersecting with the first direction; and
in the via layer, connecting the first stripe pattern to the second stripe pattern by disposing a via pattern at a grid point on which the first track three-dimensionally intersects with the second track.

7. The exposure data generation method according to claim 6,
wherein the multi-layer wiring pattern to be generated according to the wiring rule is generated by:
further disposing a dummy pattern at the grid point not included in the disposed first stripe pattern among the grid point included in the first wiring layer; and
disposing a dummy pattern at the grid point not included in the disposed second stripe pattern among the grid point included in the second wiring layer.

8. The exposure data generation method according to claim 6,
wherein the multi-layer wiring pattern to be generated according to the wiring rule is generated by:
further, in the via layer, disposing an auxiliary via pattern at the grid point adjacent to the via pattern; and
disposing a third stripe pattern on an area including an area, which is between a stripe pattern not connected to the auxiliary via pattern among the first stripe pattern and the second stripe pattern to be connected with each other by the via pattern, and the grid point at which the auxiliary via is disposed.

9. The exposure data generation method according to claim 8,
wherein the multi-layer wiring pattern to be generated according to the wiring rule is generated by:
restricting the grid point at which the auxiliary via pattern is disposed to the grid point included in a part of tracks among the first track; or
restricting the grid point at which the auxiliary via pattern is disposed to a grid point included in a portion of tracks among the second track.

10. The exposure data generation method according to claim 6,
wherein the partial patterns forming the subfield pattern of the first wiring layer include:
a first base pattern including a first isolated pattern disposed at the grid point; and
a first wiring formation pattern including a connection pattern disposed between the first isolated patterns or between an outer circumference of the first base pattern and the first isolated pattern, and
wherein the partial patterns forming the subfield pattern of the second wiring layer include:
the first base pattern; and
a second wiring formation pattern including a connection pattern disposed between the first isolated patterns or between the outer circumference of concern and the first isolated pattern, and
wherein each of the first wiring formation pattern and the second wiring formation pattern is narrower than the subfield.

11. The exposure data generation method according to claim 6 ,
wherein the partial patterns forming the subfield pattern of the first wiring layer include:
a second base pattern in which a pattern pair which includes a fourth stripe pattern, extending to the first direction and including the grid point at both ends, and a second isolated pattern disposed at the grid point adjacent to the fourth stripe pattern on the extended line of the fourth stripe pattern, is periodically disposed in the first direction and the second direction; and
a third wiring formation pattern including a connection pattern to be disposed between the fourth stripe pattern and the second isolated pattern or between an outer circumference of the second base pattern and the pattern pairs, and
wherein the partial patterns forming the subfield pattern of the second wiring layer include:
a third base pattern including third isolated pattern disposed at each of the grid point; and
a fourth wiring formation pattern including a connection pattern to be disposed between the third isolated pattern or between an outer circumference of the third base pattern and the third isolated pattern, and
wherein each of the third wiring formation pattern and the fourth wiring formation pattern is narrower than the subfield.
